(19) United States
(12) Patent Application Publication
(10) Pub. No.: US 2025/0262842 A1
(43) Pub. Date: Aug. 21, 2025

(54) IMPACT-RESISTANT GLASS-POLYMER LAMINATES AND SENSORS INCORPORATING THE SAME

(71) Applicant: CORNING INCORPORATED, CORNING, NY (US)

(72) Inventors: Thomas Michael Cleary, Elmira, NY (US); Matthew John Dejneka, Corning, NY (US); Petr Gorelchenko, Elmira, NY (US); Manuela Ocampo Davila, Corning, NY (US); Amber Leigh Tremper, Painted Post, NY (US); Jonathan Earl Walter, Woodhull, NY (US)

(21) Appl. No.: 18/858,468

(22) PCT Filed: Apr. 19, 2023
(86) PCT No.: PCT/US2023/019074

§ 371 Date: Oct. 21, 2024

Related U.S. Application Data
(60) Provisional application No. 63/335,827, filed on Apr. 28, 2022.

(51) Int. Cl. B32B 17/10; B32B 1/00; B32B 7/027; B32B 7/12; G01S 7/481

(52) U.S. Cl. CPC B32B 17/10045; B32B 1/00; B32B 7/027; B32B 7/12; B32B 17/101; G01S 7/481; B32B 2307/30; B32B 2307/412; B32B 2307/558; B32B 2307/7376; B32B 2457/00; B32B 2605/08

(57) ABSTRACT

Described are glass articles comprising a first glass-based layer, a second glass-based layer, and a polymer layer disposed between the first glass-based layer and the second glass-based layer. The first and second glass-based layers may comprise coefficients of thermal expansion that differ from one another by at least 0.5 ppm/° C. The first glass-based layer may comprise a thickness that is less than or equal to 300 μm, while the second glass-based layer may comprise a thickness that is greater than 2.0 mm. The second-glass based layer may provide structural rigidity to the article, while the first glass-based layer may render impact-induced damage less visible and less prone to negatively effecting optical performance.

### PRIORITY

This application claims the benefit of priority under 35 U.S.C. § 119 of U.S. Provisional Application Ser. No. 63/335,827, filed on Apr. 28, 2022, the content of which is relied upon and incorporated herein by reference in its entirety.

### TECHNICAL FIELD

This application relates to glass-polymer laminates and, particularly, to glass-polymer laminates for use with sensing systems, such as light detection and ranging (“LiDAR”) systems.

### BACKGROUND

Light detection and ranging (“LiDAR”) systems comprise a laser and a sensor. The laser emits a laser beam, which may reflect off an object, and the sensor detects the reflected laser beam. The laser beams are pulsed or otherwise distributed across a radial range to detect objects across a field of view. Information about the object can be deciphered from the properties of the detected reflected laser beam. Distance of the object from the laser beam can be determined from the time of flight from emission of the laser beam to detection of the reflected laser beam. If the object is moving, path and velocity of the object can be determined from shifts in radial position of the emitted laser beam being reflected and detected as a function of time, as well as from Doppler frequency measurements.

Vehicles are a potential application for LiDAR systems, with the LiDAR systems providing spatial mapping capability to enable assisted, semi-autonomous, or fully autonomous driving. Conventionally, the laser emitter and sensor are mounted on the roof of the vehicle or on a low forward portion of the vehicle. Lasers emitting electromagnetic radiation having a wavelength outside the range of visible light, such as at or near 905 nm or 1550 nm are considered for vehicle LiDAR applications. To protect the laser and sensor from impact from rocks and other objects, a window is placed between the laser and sensor, and the external environment in the line of sight of the laser and sensor. However, there is a problem in that impacting rocks and other objects scratch and cause other types of damage to the window, which cause the window to scatter the emitted and reflected laser beams, thus impairing the effectiveness of the LiDAR system.

### SUMMARY

An aspect (1) of the present disclosure pertains to an article comprising a first glass-based layer having a thickness t_{G1} and a coefficient of thermal expansion CTE_{G1}; a second glass-based layer having a thickness t_{G2} and a coefficient of thermal expansion CTE_{G2}; and a first polymer layer disposed between the first glass-based layer and the second glass-based layer having a thickness t_{P1} and a coefficient of thermal expansion CTE_{P1}, wherein: the first glass-based layer comprises a compressive stress, |CTE_{G1}−CTE_{G2}|>0.5 ppm/° C., t_{G2} is greater than 2.0 mm, and t_{G1} is less than or equal to 300 μm.

An aspect (2) of the present disclosure pertains to an article according to the aspect (1), wherein: t_{G1} is less than or equal to 200 μm, and t_{G2} is greater than 2.5 mm and less than or equal to 3.8 mm.

An aspect (3) of the present disclosure pertains to an article according to the aspect (2), wherein: the compressive stress is greater than or equal to 5 MPa and less than or equal to 40 MPa, and the second glass layer comprises a tensile stress that is less than or equal to 10 MPa.

An aspect (4) of the present disclosure pertains to an article according to any of the aspects (1)-(3), wherein: t_{G1} is less than or equal to 150 μm, and t_{G2} is greater than or equal to 2.5 and less than or equal to 3.8 mm.

An aspect (5) of the present disclosure pertains to an article according to any of the aspects (1)-(5), wherein the first glass-based layer is formed from a glass exhibiting an anomalous fracture behavior when subjected to a Vickers diamond indenter test.

An aspect (6) of the present disclosure pertains to an article according to any of the aspects (1)-(5), wherein the first glass-based layer is not chemically strengthened and the compressive stress arises from laminating the first glass-based layer to the second glass-based layer via the first polymer layer at a curing temperature differs from a usage temperature of the article by at least 20° C.

An aspect (7) of the present disclosure pertains to an article according to the aspect (6) wherein CTE_{G1}<CTE_{G2} and the curing temperature is greater than or equal to 30° C.

An aspect (8) of the present disclosure pertains to an article according to any of the aspects (1)-(7), wherein the second glass-based layer comprises a soda-lime glass.

An aspect (9) of the present disclosure pertains to an article according to the aspect (1), further comprising: a third glass-based layer having a thickness t_{G3} and a coefficient of thermal expansion CTE_{G3}, and a first polymer layer disposed between the first glass-based layer and the third glass-based layer having a thickness t_{P2} and a coefficient of thermal expansion CTE_{P2}, wherein: the second glass-based layer comprises a second compressive stress, |CTE_{G2}−CTE_{G3}|>0.5 ppm/° C., and t_{G3} is less than or equal to 20% of t_{G2}.

An aspect (10) of the present disclosure pertains to an article according to the aspect (9), wherein both t_{G1} and t_{G3} are less than or equal to 200 μm.

An aspect (11) of the present disclosure pertains to an article according to the aspect (10), wherein t_{G2} is greater than or equal to 2.5 mm and less than or equal to 3.8 mm.

An aspect (12) of the present disclosure pertains to an article according to the aspect (9), wherein the first glass-based layer and the second glass-based layer are formed of the same glass composition such that CTE_{G1}=CTE_{G3}.

An aspect (13) of the present disclosure pertains to an article according to the aspect (9), wherein t_{G1}=t_{G3} and both t_{G1} and t_{G3} are less than or equal to 150 μm.

An aspect (14) of the present disclosure pertains to an article according to any of the aspects (1)-(13), wherein a total thickness of the article is less than or equal to 4.0 mm.

An aspect (15) of the present disclosure pertains to an article according to any of the aspects (1)-(14), wherein the article is not fractured when the first glass-based layer is impacted by a Vickers diamond indenter travelling at a speed of 1000 mm/s.

An aspect (16) of the present disclosure pertains to an article according to any of the aspects (1)-(15), wherein at least one of the first-glass based layer and the second glass-based layer is warped from a process of laminating the first glass-based layer to the second glass-based layer via the first polymer layer.

An aspect (17) of the present disclosure pertains to a sensor comprising an enclosure; a detection element disposed in the enclosure; and a window attached to the enclosure so as to enclose an interior of the enclosure, wherein the window comprises: a first glass-based layer having a thickness t_{G1} and a coefficient of thermal expansion CTE_{G1}; a second glass-based layer having a thickness t_{G2} and a coefficient of thermal expansion CTE_{G2}; and a first polymer layer disposed between the first glass-based layer and the second glass-based layer having a thickness t_{P1} and a coefficient of thermal expansion CTE_{P1}, wherein: the first glass-based layer comprises a compressive stress of greater than or equal to 5 MPa and less than or equal to 40 MPa arising from a difference between CTE_{G1} and GTE_{G2}, t_{G1} is less than or equal to 300 μm, and t_{G2} is greater than 2.0 mm.

An aspect (18) of the present disclosure pertains to a sensor according to the aspect (17), wherein: t_{G1} is less than or equal to 200 μm, and t_{G2} is greater than or equal to 2.5 and less than or equal to 3.8 mm.

An aspect (19) of the present disclosure pertains to a sensor according to any of the aspects (17)-(18), wherein: the first glass-based layer is formed from a glass exhibiting an anomalous fracture behavior when subjected to a Vickers diamond indenter test, and the first glass-based layer forms an outer surface of the window that is exposed to an environment outside of the enclosure.

An aspect (20) of the present disclosure pertains to a sensor according to any of the aspects (17)-(19), wherein the first glass-based layer is not chemically strengthened and the compressive stress arises from laminating the first glass-based layer to the second glass-based layer via the polymer layer at a curing temperature that is greater than or equal to 50° C.

An aspect (21) of the present disclosure pertains to a sensor according to any of the aspects (17)-(20), further comprising: a third glass-based layer having a thickness t_{G3} and a coefficient of thermal expansion CTE_{G3}, and a second polymer layer disposed between the first glass-based layer and the third glass-based layer having a thickness t_{P2} and a coefficient of thermal expansion CTE_{P2}, wherein: the second glass-based layer comprises a second compressive stress, |CTE_{G2}−CTE_{G3}|>0.5 ppm/° C., and t_{G3} is less than or equal to 10% of t_{G2}.

An aspect (22) of the present disclosure pertains to a sensor according to the aspect (21), wherein both t_{G1} and t_{G3} are less than or equal to 200 μm.

An aspect (23) of the present disclosure pertains to a sensor according to the aspect (22), wherein t_{G2} is greater than or equal to 2.5 mm and less than or equal to 3.8 mm.

An aspect (24) of the present disclosure pertains to a sensor according to the aspect (21), wherein the first glass-based layer and the third glass-based layer are formed of the same glass composition such that CTE_{G1}=CTE_{G3}.

An aspect (25) of the present disclosure pertains to a sensor according to any of the aspects (21)-(24), wherein t_{G1}=t_{G3} and both t_{G1} and t_{G3} are less than or equal to 150 μm.

An aspect (26) of the present disclosure pertains to a method comprising: disposing a first polymer layer between a first glass-based layer and a second glass-based layer, wherein the first glass-based layer has a thickness that is less than or equal to 15% of a thickness of the second glass-based layer and wherein the thickness of the second glass-based layer is greater than 2.0 mm; curing the first polymer layer in an environment at a curing temperature T_{C} to form an article; and after the curing, returning a temperature of the first glass-based layer and the second glass-based layer to a usage temperature that is greater than or equal to 0° C. and less than or equal to 30° C., wherein: a first coefficient of thermal expansion of the first glass-based layer differs from a second coefficient of thermal expansion of the second glass-based layer by at least 0.5 ppm/° C., and T_{C} differs from the usage temperature by at least 20° C. such that returning the temperature to the usage temperature results in the first glass-based layer having a compressive stress that is greater than or equal to 5 MPa and less than or equal to 40 MPa.

An aspect (27) of the present disclosure pertains to a method according to the aspect (26), further comprising, prior to the curing, disposing a second polymer layer between the first glass-based layer and a third glass-based layer, wherein the third glass-based layer has a thickness that is less than or equal to 10% of a thickness of the second glass-based layer.

An aspect (28) of the present disclosure pertains to a method according to the aspect (27), wherein a third coefficient of thermal expansion of the third glass-based layer differs from the second coefficient of thermal expansion by at least 0.5 ppm/° C. such that, after being returned to the usage temperature, the third glass-based layer comprises a second compressive stress.

An aspect (29) of the present disclosure pertains to a method according to any of the aspects (27)-(28), wherein the third glass-based layer and the first glass-based layer comprise the same thickness and are formed of the same glass composition.

An aspect (30) of the present disclosure pertains to a method according to any of the aspects (27)-(29), wherein the first glass-based layer and the third glass-based layer are both formed from glasses exhibiting an anomalous fracture behavior when subjected to a Vickers diamond indenter test.

Additional features and advantages will be set forth in the detailed description which follows, and in part will be readily apparent to those skilled in the art from that description or recognized by practicing the embodiments as described herein, comprising the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a side view of a vehicle having a LiDAR system mounted on a roof of the vehicle and a LiDAR system mounted on a forward portion of the vehicle, according to one or more embodiments of the present disclosure;

FIG. 2 is a conceptual view of one of the LiDAR systems of FIG. 1, comprising a cover window, according to one or more embodiments of the present disclosure;

FIG. 3 is a cross-sectional view of a glass-polymer laminate that may be incorporated into the window of FIG. 2, according to one or more embodiments of the present disclosure;

FIG. 4 is a cross-sectional view of a second embodiment of a glass-polymer laminate that may be incorporated into the window of FIG. 2, according to one or more embodiments of the present disclosure;

FIG. 5 is a cross-sectional view of a curved glass-polymer laminate that may be incorporated into the window of FIG. 2, according to one or more embodiments of the present disclosure;

FIG. 6 is a chart of measured optical transmission spectra of various monolithic glass substrates and a glass-polymer laminate, according to one or more embodiments of the present disclosure;

FIG. 7 is images of first and second example glass-polymer laminates comprising two relatively thick glass layers and a polymer layer after undergoing sharp impact testing according to one or more embodiments of the present disclosure;

FIG. 8 is images of third and fourth example glass-polymer laminates comprising a relatively thick inner glass layer, a polymer layer, and a relatively thin outer glass layer after undergoing sharp impact testing, according to one or more embodiments of the present disclosure;

FIG. 9 is images of fifth and sixth example glass-polymer laminates, with the fifth example comprising a relatively thick inner glass layer surrounded by two relatively thin outer glass layers, and the sixth example comprising two relatively thin outer glass layers disposed on one side of a relatively thick inner glass layer, after undergoing sharp impact testing according to one or more embodiments of the present disclosure;

FIG. 10 is an image of a test setup for dynamic load impact testing of example glass-polymer laminates, according to one or more embodiments of the present disclosure;

FIG. 11 is images of samples of a seventh example glass-polymer laminate after undergoing impact testing at a plurality of impact velocities, according to one or more embodiments of the present disclosure;

FIG. 12 is images of samples of an eighth example glass-polymer laminate after undergoing impact testing at a plurality of impact velocities, according to one or more embodiments of the present disclosure;

FIG. 13 is images of samples of a ninth example glass-polymer laminate after undergoing impact testing at a plurality of impact velocities, according to one or more embodiments of the present disclosure;

FIG. 14 is images of samples of a tenth example glass-polymer laminate after undergoing impact testing at a plurality of impact velocities, according to one or more embodiments of the present disclosure;

FIG. 15 is images of samples of an eleventh example glass-polymer laminate after undergoing impact testing at a plurality of impact velocities, according to one or more embodiments of the present disclosure; and

FIG. 16 is images of samples of a twelfth example glass-polymer laminate after undergoing impact testing at a plurality of impact velocities, according to one or more embodiments of the present disclosure.

### DETAILED DESCRIPTION

Reference will now be made in detail to the present embodiments, examples of which are illustrated in the accompanying drawings. Whenever possible, the same reference numerals will be used throughout the drawings to refer to the same or like parts. Referring generally to the figures, described herein are impact resistant glass-polymer laminates. The impact resistant glass-polymer laminates may find use in a variety of applications, including, but not limited to sensor windows. For example, the glass-polymer laminates described herein may find use in a cover window for a camera or LIDAR sensor system associated with a vehicle (e.g., an automobile, a locomotive, a watercraft, an aircraft, a satellite). The glass-polymer laminates may be more resistant to damage from typically-encountered impact events (e.g., from rocks, stones, or sandblasting associated with an exterior of a vehicle) than certain existing forms of cover materials used for cover window applications (e.g., chemically strengthened glass, glass-glass laminates, plastics). Particularly, the glass-polymer laminates described herein may comprise two or more glass-based layers, with at least two adjacent ones of the glass-based layers differing from one another in terms of coefficient of thermal expansion (“CTE”) by at least 0.5 ppm/° C. The adjacent glass-based layers are separated from one another by polymer layers. During construction of the glass-polymer laminates described herein, a stack of at least a first glass-based layer, a first polymer layer, and a second glass-based layer is heated to a curing temperature that differs from an intended usage temperature of the laminate (associated with typical operating conditions of the sensor). When at the curing temperature, the polymer layer is cured (e.g., either by application of radiation thereto or via temperature treatments). The stack is subsequently heated or cooled to the usage temperature, such that the CTE differential between the glass-based layers leads to one of the glass-based layers having a compressive stress therein. The compressive stress beneficially improves the impact performance of that glass-based layer, providing favorable performance characteristics for various sensor or other applications where resistance to damage from impact events is desired.

In aspects, the glass-polymer laminates described herein may be implemented as a cover window for various sensor applications, with at least one glass-based layer having compressive stress therein being situated so as to face the external environment of the sensor, as an outer glass-based layer. It has been found that it is particularly beneficial from an impact performance perspective when the thickness of the outer glass-based layer is substantially smaller than an inner glass-based layer (e.g., that is positioned more proximate to the sensor than the outer glass-based layer). In embodiments, the outer glass-based layer comprises a thickness that is less than or equal to 20% (e.g., less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%) of a thickness of the inner glass-based layer. For example, in embodiments, the outer glass-based layer comprises a thickness that is greater than or equal to 10 μm and less than or equal to 300 μm, while the inner glass based layer comprises a thickness that is greater than 2.0 mm (e.g., greater than or equal to 2.1 mm and less than or equal to 4.0 mm, greater than or equal to 2.2 mm and less than or equal to 4.0 mm, greater than or equal to 2.3 mm and less than or equal to 4.0 mm, greater than or equal to 2.4 mm and less than or equal to 4.0 mm, greater than or equal to 2.5 mm and less than or equal to 3.8 mm). It has been found that such a relatively thin outer glass-based layer may prevent impact events from negatively impacting optical performance by preventing flaws (e.g., cracks) from impacts from propagating out of a plane of initiation, thereby reducing the extent that the flaws inhibit optical performance by reducing the scattering cross-section thereof. When propagating through thicker pieces of glass, impact-initiated cracks may twist out of plane, thereby increasing the reflectance of the laminate and reducing window performance (e.g., transmission). The relatively thin outer glass-based layers described herein prevent such twisting and aid in maintaining optical performance despite any impact-induced defects.

The relatively thick inner glass-based layers described herein beneficially provide stiffness and avoid lamination-induced warpage. When incorporating an asymmetrical structure (e.g., in terms of the thicknesses of the glass-based layers on either side of a geometric center of a cross-section of the laminate), the glass-polymer laminates described herein have asymmetric CTE-induced stress distributions. In embodiments, such asymmetric stress distributions may cause warpage of the laminate (e.g., bending of the laminate from the differential expansion and contraction of the layers). However, it has been found that maintaining the thickness of the inner glass-based layer above 2.0 mm (e.g., greater than or equal to 2.1 mm, greater than or equal to 2.2 mm, greater than or equal to 2.3 mm, greater than or equal to 2.4 mm, greater than or equal to 2.5 mm, greater than or equal to 2.6 mm, greater than or equal to 2.7 mm, greater than or equal to 2.8 mm, greater than or equal to 2.9 mm, greater than or equal to 3.0 mm, greater than or equal to 2.5 mm and less than or equal to 3.8 mm) provides sufficient stiffness to prevent such warpage, thereby enabling the glass-based layers to retain an initial shape during and after lamination (e.g., the glass-based layers may remain planar glass-sheets throughout the lamination process to form a planar sensor window).

By enabling asymmetrical laminate structures, the relatively thick inner glass-based layers of the glass-polymer laminates described herein may also aid in reducing the polymer layers incorporated into the laminate (e.g., such that polymer layers are only located on one side of the inner glass-based layer). Reducing the polymer layers may beneficially maintain the optical transmission of the laminate throughout a sensing wavelength band suitably high for a particular sensor application. The relatively thick inner glass-based layers described herein thus facilitate favorable optical performance of the glass-polymer laminates by controlling shape of the laminates and reducing the need for polymer-based material.

In aspects, the glass-polymer laminates described herein may comprise a plurality of relatively thin outer glass-based layers disposed on one side of the relatively thick inner glass-based layer. In an example, a glass-polymer laminate according to the present disclosure may comprise an inner glass-based layer, a first polymer layer disposed on the inner glass-based layer, a first outer glass-based layer disposed on the first polymer layer, a second polymer layer disposed on the first outer glass-based layer, and a second outer glass-based layer disposed on the second polymer layer. The additional outer glass-based layer beneficially increases the thickness of the glass that can be damaged with only minimal visibility (e.g., if an impact-induced crack propagates into the first outer glass-based layer from the second outer glass-based layer, the crack also has to propagate through the first outer glass-based layer prior to reaching the inner glass-based layer and twisting out of plane to become more visible). Moreover, such multi outer glass-based layer embodiments introduce additional layers of polymer material. As described herein, such layers may deform and attenuate impact energy, rendering impact-induced damage less severe. Any number of outer glass-based layers may be incorporated into the glass-polymer laminates described herein to provide a desired level of impact performance, with the understanding that additional polymer layers may degrade optical transmission performance.

In embodiments, the outer glass-based layers are formed of an anomalous glass composition. An anomalous glass is a glass that tends to exhibit crack-loop fracture behavior where ring cracks surround an initial indention site when the glass is subjected to the Vickers indenter test described in Gross et al., Crack-resistant glass with high shear band density, Journal of Non-Crystalline Solids, 494 (2018) 13-20; and Gross, Deformation and cracking behavior of glasses indented with diamond tips of various sharpness, Journal of Non-Crystalline Solids, 358 (2012) 3445-3452, both of which are incorporated in their entireties. Examples of anomalous glass may be borosilicate glasses (such as the glasses described in PCT Patent Application No. PCT/US2021/61966, filed on Dec. 6, 2021, hereby incorporated by reference in its entirety, or Corning® Eagle XG® glass or 714AWF glass) or glasses with relatively high silica contents. Such glasses tend to exhibit impact performance characteristics that are favorable over glasses exhibiting normal fracture behavior, where cracks extending radially from the indentation site tend to extend through the thickness of the glass, potentially leading to catastrophic failure. Anomalous glasses such as borosilicates may also tend to exhibit relatively low CTEs, limiting thermally-induced damage from environmental exposure.

As used herein, the term “coefficient of thermal expansion” or CTE means a value obtained by measuring expansion of the referred to material between the temperatures of 0° C. and 300° C.

As used herein, the term “dispose” comprises coating, depositing and/or forming a material onto a surface using any known method in the art. The disposed material may constitute a layer, as defined herein. The phrase “disposed on” comprises the instance of forming a material onto a surface such that the material is in direct contact with the surface and also comprises the instance where the material is formed on a surface, with one or more intervening material(s) between the disposed material and the surface. The intervening material(s) may constitute a layer, as defined herein.

Ranges can be expressed herein as from “about” one particular value, and/or to “about” another particular value. When such a range is expressed, another embodiment comprises from the one particular value and/or to the other particular value (i.e., the range is inclusive of the expressly stated endpoints). Similarly, when values are expressed as approximations, by use of the antecedent “about,” it will be understood that the particular value forms another embodiment. For example, the range “from about 1 to about 2” also expressly comprises the range “from 1 to 2”. Similarly, the range “about 1 to about 2” also expressly comprises the range of “1 to 2”. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, comprising: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” comprise plural referents unless the context clearly dictates otherwise. Thus, for example, reference to “a” component comprises aspects having two or more such components, unless the context clearly indicates otherwise.

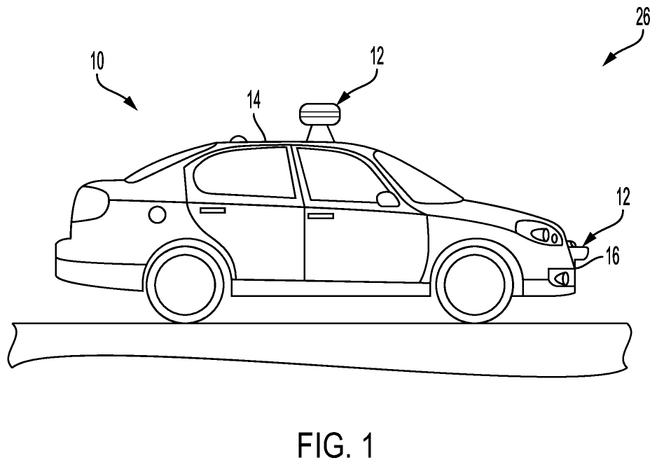

Referring now to FIG. 1, a vehicle 10 comprises one or more LiDAR systems 12. The one or more LiDAR systems 12 can be disposed anywhere on or within the vehicle 10. For example, the one or more LiDAR systems 12 can be disposed on a roof 14 of the vehicle 10 and/or a forward portion 16 of the vehicle 10.

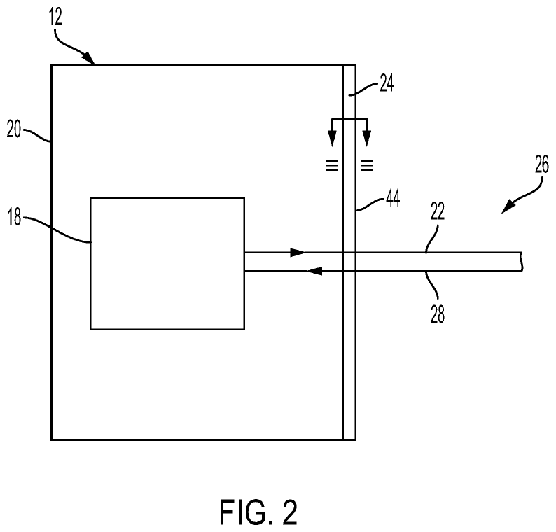

Referring now to FIG. 2, each of the one or more LiDAR systems 12 comprise an electromagnetic radiation emitter and sensor 18, as known in the art, which may be enclosed in an enclosure 20. The electromagnetic radiation emitter and sensor 18 emits emitted radiation 22 having a wavelength or range of wavelengths. The emitted radiation 22 exits the enclosure 20 through a window 24. If an object (not illustrated) in an external environment 26 is in the path of the emitted radiation 22, the emitted radiation 22 will reflect off of the object and return to the electromagnetic radiation emitter and sensor 18 as reflected radiation 28, being initially incident on an outer surface 44 of the window. The outer surface 44 is the surface of the window 24 that is exposed (or most proximate to) the external environment of the LiDAR system 12, such that the outer surface 44 is exposed to conditions that are not regulated within the enclosure 20. After being incident on the outer surface 44, the reflected radiation 28 again passes through the window 24 to reach the electromagnetic radiation emitter and sensor 18. In embodiments, the emitted radiation 22 and the reflected radiation 28 has a wavelength of 905 nm or 1550 nm or has a bandwidth comprising either 905 nm (e.g., from 880 nm to 930 nm) or 1550 nm (e.g., from 1525 nm to 1775 nm). Electromagnetic radiation other than the reflected radiation 28 (such as electromagnetic radiation having wavelengths in the visible spectrum) may or may not pass through the window 24, depending on the optical properties of the window 24 as described herein. As used herein, the term “visible spectrum” is used to refer to the portion of the electromagnetic spectrum that is visible to the human eye and generally refers to electromagnetic radiation having a wavelength within the range of about 380 nm to 700 nm.

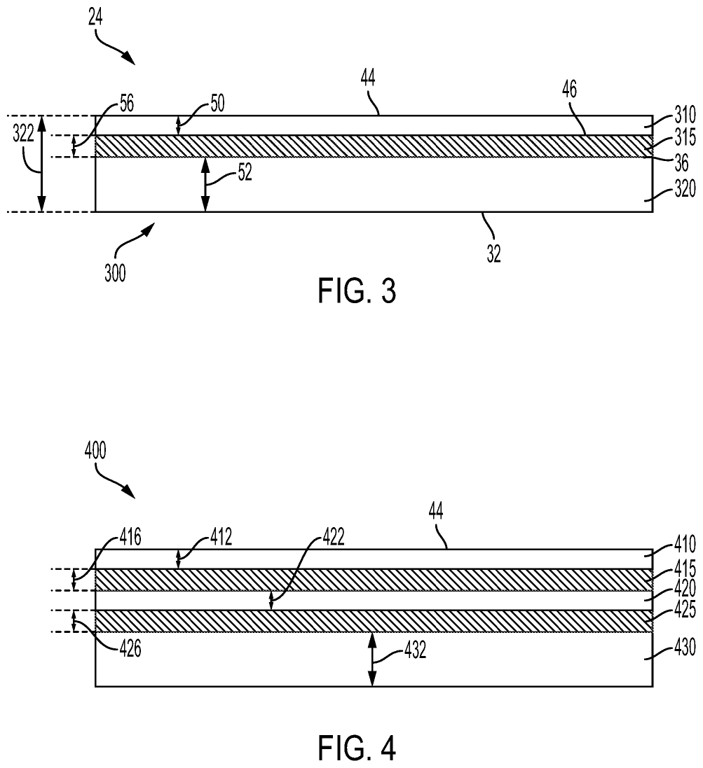

Referring now to FIG. 3, in embodiments, the window 24 for each of the one or more LiDAR systems 12 may comprise a glass-polymer laminate 300. The glass-polymer laminate 300 comprises a first surface 32 and the outer surface 44. The first surface 32 and the outer surface 44 are the primary surfaces of the glass-polymer laminate 300. In embodiments, and with reference to FIG. 2, the outer surface 44 is closest to the external environment 26. The first surface 32 is closest to the electromagnetic radiation emitter and sensor 18. The emitted radiation 22 encounters the first surface 32 before the outer surface 44. The reflected radiation 28 encounters the outer surface 44 before the first surface 32.

In embodiments, one or more of the first surface 32 and the outer surface 44 of the window may comprise one or more suitable surface treatments. For example, in embodiments, at least one of the first surface 32 and the outer surface 44 comprises an anti-reflective film. The anti-reflective film(s) may be tailored to prevent reflection of the emitted radiation 22 and the reflected radiation 28. In embodiments, the anti-reflective film comprises a plurality of alternating layers of relatively low and high refractive index materials of suitable thickness to provide relatively low reflectance and high transmittance at within a particular wavelength range of interest. Any of the anti-reflective films described in International Patent Application No. PCT/US2020/35034, filed on May 29, 2020, International Patent Application No. PCT/US2020/35497, Filed on Jun. 1, 2020, U.S. Provisional Patent Application No. 63/284,161, filed on Nov. 30, 2021, U.S. Provisional Patent Application No. 63/289,828, filed on Dec. 15, 2021, U.S. Provisional Patent Application No. 63/257,814, filed on Oct. 20, 2021, each of which is incorporated by reference in its entirety, may be used in conjunction with the glass-laminate 300. In embodiments, one of the high refractive index layers of the anti-reflective film comprises a relatively high thickness of 1000 nm, such that the glass-polymer laminate 300 has a maximum hardness, measured by the Berkovich Indenter Hardness Test, of at least 8 GPa, when measured on the side of the anti-reflective film. As such, the construction of the anti-reflective film may enhance the impact performance of the glass-polymer laminate 300.

The glass-polymer laminate 300 depicted in FIG. 3 comprises a first glass-based layer 310, a second glass-based layer 320, and a first polymer layer 315 disposed between the first and second glass-based layers 310 and 320. As shown, the first glass-based layer 310 forms the outer surface 44 of the window 24 (see FIG. 2). As such, in the depicted example, the first glass-based layer 310 forms an outer glass-based layer, while the second glass-based layer 320 forms an inner glass-based layer.

The first glass-based layer 310 may have a coefficient of thermal expansion (CTE) that is substantially different than the CTE of the second glass-based layer 320. For example, the first glass-based layer 310 may have a low CTE while the second glass-based layer 320 exhibits a higher CTE than the first glass-based layer 310. The first polymer layer 315 may comprise a UV or thermal cure polymer. Curing the polymer at a temperature distanced from the intended usage temperature (such as room temperature) leads to the CTE differential between the glass-based layers to create a compressive stress on the first glass-based layer 310 as the glass-polymer laminate 300 is returned to the usage temperature. The compressive stress on the first glass-based layer 310 provides increased damage resistance and improved scratch performance. Any cracks that do form in the first glass-based layer 310 are arrested at the polymer interface due to the ductile deformation of the first polymer layer 315 (unlike the brittle deformation at the interface in fused laminates) and may not propagate into the second glass-based layer 320, reducing the visibility of the cracks and preventing catastrophic failure of the glass-polymer laminate 300.

Keeping the first glass-based layer 310 thin (e.g., such that a thickness 50 thereof is less than or equal to 300 μm) may aid in minimizing the visibility of any cracks formed therein. Using a damage resistant material, such as borosilicates, alkaline earth aluminoborosilicates or alkali aluminoborosilicates, for the first glass-based layer 310 provides further improved impact performance than monolithic ion exchanged glass materials, which are more prone to lateral cracking because of their large surface stress gradient.

In embodiments, the material out of which the first polymer layer 315 is formed is selected to be stiff at relatively low thicknesses, preventing sharp flexure and breakage of the first and second glass-based layers 310 and 320. Polymers having relatively high elastic moduli, relatively high glass transition temperatures, and relatively low ductile to brittle transformation temperature have been found to beneficially effect performance. In addition to a variety of UV and thermally curable polymers, film polymer laminations may be employed. Commercially available polymers, such as those described in International Patent Application No. PCT/US2021/60757, filed on Nov. 24, 2021, hereby incorporated by reference in its entirety, may be used to form the polymer layers described herein.

Referring still to FIG. 3, the structure of the glass-polymer laminate 300 provides a number of advantages when compared to monolithic chemically or thermally strengthened glass-based articles, such as those that are commercially available. The laminate structure provides performance comparable to that of chemically strengthened glass articles without requiring an ion exchange treatment, reducing cost for the same level of performance. Additionally, the visibility of defects in the glass-based laminate 300 is less objectionable over a broader range of impact events than monolithic chemically strengthened glass-based articles, reducing the frequency of replacement during usage. The glass-based laminate 300 may also exhibit some degree of self-healing, such that cracks that do form become less visible over time, due to the compressive stress in the first glass-based layer 310. From a fabrication perspective, the glass-based laminate 300 described herein may be cut from “mother” sheets to desired part size even after the introduction of the compressive stress, which is difficult or impossible with monolithic chemically strengthened glass-based articles. The glass-based laminate articles may also be considered repairable, such that the application of a curable resin may reduce the appearance of cracks.

In embodiments, the compressive stress in the first glass-based layer 310 originates from the coefficient of thermal expansion mismatch between the first and second glass-based layers 310 and 320. The material of the first polymer layer 315 is cured at a temperature (e.g., heated to a curing temperature) different than the intended usage temperature (typically room temperature), and, as the laminate is returned to the usage temperature, the volumetric change of the higher coefficient of thermal expansion (CTE) second glass-based layer 320 is larger than the volumetric change of the lower CTE first glass-based layer 310, which produces a compressive stress in the first glass-based layer 310.

In embodiments, the greater the CTE difference in the glasses of the first glass-based layer 310 and the second glass-based layer 320, and the greater the temperature difference between the curing temperature and the usage temperature, the greater the compressive stress produced. In addition to CTEs of the glasses of the first glass-based layer 310 and the second glass-based layer 320, the glass relaxation behavior of the polymer out of which the first polymer layer 315 is formed has a considerable influence on the final stress state in the glass-based laminate articles. Glass transition temperature, processing temperature, cooling rate and elastic modulus of the polymer in rubbery state are important controlling parameters.

The first polymer layer 315 serves multiple purposes. Perhaps most importantly, the first polymer layer 315 provides the mechanical bond between the first and second glass-based layers 310 and 320. The shrinkage of the first polymer layer 315 during the curing process may impart an additional compressive stress force on the first and second glass-based layers 310 and 320 to which it is bonded and is a reason that the glass-polymer laminates described herein may exhibit slightly more compressive stress than attributable to just the CTE mismatch between the first and second glass-based layers 310 and 320. This additional compression adds to the damage resistance and strength of the glass-polymer laminate 300. Additionally, the first polymer layer 315 deflects and arrests any cracks that may propagate from one glass-based layer into another. Thus, if the surface of the second glass-based layer 320 is pristine and free of strength limiting flaws it is expected to remain so during use because it is protected by the first glass-based layer 310 and first polymer layer 315, imparting great strength to the glass-polymer laminate 300 even if the first glass-based layer 310 is insulted or damaged. In order to act in this manner, the polymer ductile to brittle transformation temperature should be low, such that the deformation in the first polymer layer 315 is either purely elastic or elastic/plastic/viscoplastic within an operating temperature range (e.g., from −30° C. to 50° C., from −10° C. to 50° C., from 0° C. to 30° C.). Finally, the first polymer layer 315 helps to hold any cracks that do form in the glass-based layers closed.

As shown in FIG. 3, the first glass-based layer 310 comprises a thickness 50 (e.g., measured between the outer surface 44 and a second major surface 46 of the first glass-based layer 310). The first glass-based layer 310 may be formed from a first glass composition and comprise a first coefficient of thermal expansion CTEG1. The second glass-based layer 320 comprises a thickness 52 (e.g., between the first surface 32 and a second major surface 36 of the second glass-based layer 320). The second glass-based layer 320 may be formed from a second glass composition and comprise a second coefficient of thermal expansion CTEG2. The first polymer layer 315 comprises a thickness 56 and a coefficient of thermal expansion CTEP1. In embodiments, the difference between CTEG1 and CTEG2 is greater than or equal to 0.5 ppm/° C. to facilitate strength-enhancing compressive stress being present in the first glass-based layer 310 after lamination.

The thickness 50 of the first glass-based layer 310 is depicted to be less than the thickness 52 of the second glass-based layer 320. In embodiments, the thickness 50 is less than or equal to 20% of the thickness 52 (e.g., less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%). In embodiments, the thickness 50 is less than or equal to 300 μm and greater than or equal to 10 μm (e.g., less than or equal to 250 μm, less than or equal to 200 μm, less than or equal to 190 μm, less than or equal to 180 μm, less than or equal to 170 μm, less than or equal to 160 μm, less than or equal to 150 μm, less than or equal to 140 μm, less than or equal to 130 μm, less than or equal to 120 μm, less than or equal to 110 μm, less than or equal to 100 μm, less than or equal to 90 μm, or less), while the thickness 52 is greater than 2.0 mm (e.g., greater than or equal to 2.1 mm, greater than or equal to 2.2 mm, greater than or equal to 2.3 mm, greater than or equal to 2.4 mm, greater than or equal to 2.5 mm, greater than or equal to 2.6 mm, greater than or equal to 2.7 mm, greater than or equal to 2.8 mm, greater than or equal to 2.9 mm, greater than or equal to 3.0 mm, greater than or equal to 2.5 mm, all while less than or equal to 3.8 mm). The relatively low thickness of the first glass-based layer 310 may render any impact-induced damage on the outer surface 44 less visible by preventing cracks from twisting out of plane and covering more surface area in a direction perpendicular to the emitted radiation 22 (see FIG. 2), thereby reducing the scattering cross-section of the damage. The relatively low thickness of the first glass-based layer 310 may also allow the first glass-based layer 310 to bend and dissipate impact energy, reducing or preventing fracture. The relatively high thickness of the second glass-based layer 320 adds stiffness to the glass-polymer laminate 300 and prevents warpage from the lamination process, despite the asymmetrical structure of the glass-polymer laminate 300.

In embodiments, the thickness 56 is less than the thickness 52. In embodiments, all of the polymer layers disposed between the glass-based layers in the glass-polymer laminates described herein may, individually, have a thickness of less than or equal to 150 μm. In embodiments, the thickness 56 is less than or equal to 150 μm, such as less than or equal to 145 μm, less than or equal to 140 μm, less than or equal to 135 μm, less than or equal to 130 μm, less than or equal to 125 μm, less than or equal to 120 μm, less than or equal to 115 μm, less than or equal to 110 μm, less than or equal to 105 μm, less than or equal to 100 μm, less than or equal to 95 μm, less than or equal to 90 μm, less than or equal to 85 μm, less than or equal to 80 μm, less than or equal to 75 μm, less than or equal to 70 μm, less than or equal to 65 μm, less than or equal to 60 μm, less than or equal to 55 μm, less than or equal to 50 μm, less than or equal to 45 μm, less than or equal to 40 μm, less than or equal to 35 μm, less than or equal to 30 μm, less than or equal to 25 μm, less than or equal to 20 μm, less than or equal to 15 μm, less than or equal to 10 μm, less than or equal to 8 μm, less than or equal to 6 μm, less than or equal to 4 μm, less than or equal to 2 μm, less than or equal to 1 μm or less. In embodiments, the thickness 56 is greater than or equal to 1 μm to less than or equal to 150 μm greater than or equal to 2 μm to less than or equal to 150 μm, such as from greater than or equal to 4 μm to less than or equal to 145 μm, from greater than or equal to 6 μm to less than or equal to 140 μm, from greater than or equal to 8 μm to less than or equal to 135 μm, from greater than or equal to 10 μm to less than or equal to 130 μm, from greater than or equal to 15 μm to less than or equal to 125 μm, from greater than or equal to 20 μm to less than or equal to 120 μm, from greater than or equal to 25 μm to less than or equal to 115 μm, from greater than or equal to 30 μm to less than or equal to 110 μm, from greater than or equal to 35 μm to less than or equal to 105 μm, from greater than or equal to 40 μm to less than or equal to 100 μm, from greater than or equal to 45 μm to less than or equal to 95 μm, from greater than or equal to 50 μm to less than or equal to 90 μm, from greater than or equal to 55 μm to less than or equal to 85 μm, from greater than or equal to 60 μm to less than or equal to 80 μm, from greater than or equal to 65 μm to less than or equal to 75 μm, from greater than or equal to 2 μm to less than or equal to 70 μm, and any and all sub-ranges formed from these endpoints. Where multiple polymer layers are comprised in the glass-polymer laminate (e.g., as described herein with respect to FIG. 4), the polymer layers article may have different thicknesses. In other embodiments, where multiple polymer layers are comprised in the glass-polymer laminate, the polymer layers may have substantially equivalent or equivalent thicknesses. In embodiments, the polymer layers may be thinner than the glass-based layers to which they are adjacent. For example, in embodiments, the thickness 56 is less than or equal to 75 μm (e.g., less than or equal to 50 μm, less than or equal to 25 μm), while the thickness 50 is greater than 75 μm (e.g., greater than or equal to 100 μm, greater than or equal to 125 μm, greater than or equal to 150 μm).

Referring still to FIG. 3, the glass-polymer laminate 300 comprises a combined thickness 322 that represents combination of the thicknesses 50, 52, and 56. In embodiments, the combined thickness 322 is less than or equal to 20 mm, such as less than or equal to 19 mm, less than or equal to 18 mm, less than or equal to 17 mm, less than or equal to 16 mm, less than or equal to 15 mm, less than or equal to 14 mm, less than or equal to 13 mm, less than or equal to 12 mm, less than or equal to 11 mm, less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, less than or equal to 1.5 mm, less than or equal to 1 mm, or less. In embodiments, the thickness of the glass-based article is from greater than or equal to 0.5 mm to less than or equal to 20 mm, such as greater than or equal to 1 mm to less than or equal to 19 mm, greater than or equal to 2 mm to less than or equal to 18 mm, greater than or equal to 3 mm to less than or equal to 17 mm, greater than or equal to 4 mm to less than or equal to 16 mm, greater than or equal to 5 mm to less than or equal to 15 mm, greater than or equal to 6 mm to less than or equal to 14 mm, greater than or equal to 7 mm to less than or equal to 13 mm, greater than or equal to 8 mm to less than or equal to 12 mm, greater than or equal to 9 mm to less than or equal to 11 mm, greater than or equal to 0.5 mm to less than or equal to 10 mm, and any and all sub-ranges formed from these endpoints.

As described herein, the first glass-based layer 310 and the second glass-based layer 320 have a coefficient of thermal expansion (CTE) mismatch. The difference in CTE between the first glass-based layer 310 and the second glass-based layer 320 is greater than 0.5 ppm/° C., such that |CTEG1−CTEG2|>0.5 ppm/° C. In embodiments, |CTEG1−CTEG2|>1 ppm/° C. In general, a greater mismatch in CTE of the glass-based layers produces greater amounts of compressive stress. In embodiments, CTEG1<CTEG2. In other embodiments, CTEG1>CTEG2. The glass-based layer with the higher CTE determines whether the curing of the polymer layer takes place above or below the usage temperature to produce a compressive stress in the first glass-based layer 310. In embodiments, where CTEG1<CTEG2 the curing temperature is greater than the usage temperature. In embodiments, where CTEG1>CTEG2 the curing temperature is lower than the usage temperature.

The relationship between the CTE of the first polymer layer 315 and the average CTE of the first and second glass-based layers 310 and 320 may also be considered. In embodiments, CTEP1−(CTEG1+CTEG2)/2>1 ppm/° C.

The first glass-based layer 310 comprises a compressive stress. The compressive stress improves the resistance of the glass-polymer laminate 300 to fracture and reduces crack propagation. In embodiments, the first glass-based layer 310 comprises a compressive stress greater than or equal to 5 MPa, such as greater than or equal to 10 MPa, greater than or equal to 15 MPa, greater than or equal to 20 MPa, greater than or equal to 25 MPa, greater than or equal to 30 MPa, greater than or equal to 35 MPa, greater than or equal to 40 MPa, greater than or equal to 45 MPa, greater than or equal to 50 MPa, greater than or equal to 55 MPa, greater than or equal to 60 MPa, greater than or equal to 65 MPa, greater than or equal to 70 MPa, greater than or equal to 75 MPa, greater than or equal to 80 MPa, greater than or equal to 85 MPa, greater than or equal to 90 MPa, greater than or equal to 95 MPa, greater than or equal to 100 MPa, or more. In embodiments, the first glass-based layer 310 comprises a compressive stress from greater than or equal to 5 MPa to less than or equal to 100 MPa, such as greater than or equal to 10 MPa to less than or equal to 95 MPa, greater than or equal to 15 MPa to less than or equal to 90 MPa, greater than or equal to 20 MPa to less than or equal to 85 MPa, greater than or equal to 25 MPa to less than or equal to 80 MPa, greater than or equal to 30 MPa to less than or equal to 75 MPa, greater than or equal to 35 MPa to less than or equal to 70 MPa, greater than or equal to 40 MPa to less than or equal to 65 MPa, greater than or equal to 45 MPa to less than or equal to 60 MPa, greater than or equal to 50 MPa to less than or equal to 55 MPa, and any and all sub-ranges formed from these endpoints.

In embodiments, the compressive stress of the first glass-based layer 310 is greater than or equal to 5 MPa and less than or equal to 40 MPa. It has been found that maintaining the compressive stress in this range is advantageous in that the tensile stress in the second glass-based layer 320 is maintained at levels less than or equal to 10 MPa (e.g., less than or equal to 9.5 MPa, less than or equal to 9.0 MPa, less than or equal to 8.5 MPa, less than or equal to 8.0 MPa, less than or equal to 7.5 MPa). Higher levels of tensile stress in the second glass-based layer 320 may increase the risk of catastrophic failure of the glass-polymer laminate 300 in response to particularly severe impact events, due to the propensity of such tensile stress to propagate flaws.

In embodiments, the first glass-based layer 310 may comprise a substantially uniform compressive stress. In embodiments, the first glass-based layer 310 comprises an average compressive stress and the compressive stress varies over the thickness of the first glass-based layer 310 by less than 20% of the average compressive stress. In such embodiments, the average compressive stress of the first glass-based layer 310 may be any of the compressive stress values described above, such as greater than or equal to 5 MPa, greater than or equal to 10 MPa, etc.

The first glass-based layer 310 may be characterized by an exposed surface compressive stress at the outer surface 44. The outer surface 44 is not in contact with the first polymer layer 315 and thus may be contacted during impact events and thus most likely to suffer damage in the course of normal use. In embodiments, the exposed surface of the first glass-based layer 310 has a compressive stress that may be any of the compressive stress values described above, such as greater than or equal to 5 MPa, greater than or equal to 10 MPa, etc.

The first glass-based layer 310 may be characterized by a bonded surface compressive stress at the second major surface 46 that is contact with the first polymer layer 315. In embodiments, the bonded surface of the first glass-based layer 310 has a compressive stress that may be any of the compressive stress values described above, such as greater than or equal to 5 MPa, greater than or equal to 10 MPa, etc. In embodiments where the compressive stress in the first glass-based layer 310 is substantially uniform, the compressive stress at the outer surface 44 may be substantially equal to the compressive stress at the second major surface 46.

In embodiments, the first glass-based layer 310 and the second glass-based layer 320 are not thermally or chemically strengthened. That is, the first and second glass compositions used to form the first glass-based layer 310 and the second glass-based layer 320 are not strengthened by immersion in a molten salt bath or subjected to thermal tempering heat treatments to form compressive stress not resulting from the CTE mismatch between the first and second glass compositions. Such embodiments may beneficially eliminate processing steps and save costs.

Embodiments are also envisioned where the first glass-based layer 310 and/or the second glass-based layer 320 are formed from a chemically strengthened glass-based material. Chemically strengthened glass-based materials comprise a stress profile that is additively combined with the compressive stress produced by the CTE mismatch of the glass-based layers, resulting in a maximum compressive stress in the first glass-based layer 310 or the second glass-based layer 320 that may be significantly higher than the compressive stress due to the CTE mismatch alone. In such embodiments, the first glass-based layer 310 and/or the second glass-based layer 320 may comprise a compressive stress greater than or equal to 200 MPa, such as greater than or equal to 250 MPa, greater than or equal to 300 MPa, greater than or equal to 350 MPa, greater than or equal to 400 MPa, greater than or equal to 450 MPa, greater than or equal to 500 MPa, greater than or equal to 550 MPa, greater than or equal to 600 MPa, greater than or equal to 650 MPa, greater than or equal to 700 MPa, greater than or equal to 750 MPa, greater than or equal to 800 MPa, greater than or equal to 850 MPa, greater than or equal to 900 MPa, greater than or equal to 950 MPa, or more. In embodiments, the first glass-based layer 310 comprises a compressive stress from greater than or equal to 200 MPa to less than or equal to 1000 MPa, such as greater than or equal to 250 MPa to less than or equal to 950 MPa, greater than or equal to 300 MPa to less than or equal to 900 MPa, greater than or equal to 350 MPa to less than or equal to 850 MPa, greater than or equal to 400 MPa to less than or equal to 800 MPa, greater than or equal to 450 MPa to less than or equal to 750 MPa, greater than or equal to 500 MPa to less than or equal to 700 MPa, greater than or equal to 550 MPa to less than or equal to 650 MPa, greater than or equal to 200 MPa to less than or equal to 600 MPa, and any and all sub-ranges formed from these endpoints.

The second glass-based layer 320 may be characterized by Young's modulus. In embodiments, the second glass-based layer 320 may have a Young's modulus EG2 greater than or equal to 5 GPa, such as greater than or equal to 10 GPa, greater than or equal to 15 GPa, greater than or equal to 20 GPa, greater than or equal to 25 GPa, greater than or equal to 30 GPa, greater than or equal to 35 GPa, greater than or equal to 40 GPa, greater than or equal to 45 GPa, greater than or equal to 50 GPa, greater than or equal to 55 GPa, greater than or equal to 60 GPa, greater than or equal to 65 GPa, greater than or equal to 70 GPa, greater than or equal to 75 GPa, or more. In embodiments, EG2 is from greater than or equal to 5 GPa to less than or equal to 80 GPa, such as greater than or equal to 10 GPa to less than or equal to 75 GPa, greater than or equal to 15 GPa to less than or equal to 70 GPa, greater than or equal to 20 GPa to less than or equal to 65 GPa, greater than or equal to 25 GPa to less than or equal to 60 GPa, greater than or equal to 30 GPa to less than or equal to 55 GPa, greater than or equal to 35 GPa to less than or equal to 50 GPa, greater than or equal to 40 GPa to less than or equal to 45 GPa, and any and all sub-ranges formed from these endpoints. Unless otherwise indicated, the Young's modulus of glass-based layers are measured by a resonant ultrasonic spectroscopy technique of the general type set forth in ASTME2001-13, titled “Standard Guide for Resonant Ultrasound Spectroscopy for Defect Detection in Both Metallic and Non-metallic Parts.”

The Young's modulus of the second glass-based layer 320 EG2 may be described in relation to a Young's modulus of the first polymer layer TP1. In embodiments, the Young's modulus of the second glass-based layer 320 is greater than the Young's modulus of the first polymer layer, such that EG2>EP1.

The glass-based layers may comprise glass or glass ceramic materials. In embodiments, the first glass-based layer 310 and the second glass-based layer 320 may have different compositions. In embodiments, the second glass-based layer 320 is formed from an aluminosilicate glass, such as an aluminosilicate glass, an aluminoborosilicate glass, a soda-lime glass. In embodiments, the first glass-based layer 310 is a borosilicate glass, an aluminoborosilicate glass, such as an alkali-free aluminoborosilicate glass.

The first and second glass-based layers 310 and 320 may be selected to provide desirable optical properties. In embodiments, the glass-based layers have a transmission of greater than or equal to 90% over a wavelength rang of interest. The wavelength range of interest may vary depending on the application. For example, when used as the window 24 of the LiDAR system 12 (see FIG. 2), the wavelength range of interest may comprise 905 nm or 1550 nm. In embodiments, the wavelength range of interest comprises a central wavelength of 905 nm or 1550 nm, and a range of wavelengths surrounding the central wavelength (e.g., +/−10 nm, +/−20 nm, +/−30 nm, +/−40 nm, +/−50 nm, +/−100 nm). In embodiments, such as for applications other than in the LiDAR system 12, like a camera cover lens, the wavelength range of interest may be the visible spectrum, or from 380 nm to 700 nm. In embodiments, the optical transmission may throughout the wavelength range of interest may be greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, or more. Unless otherwise indicated, transmission is measured with a Haze-gard Transparency Transmission Haze Meter, according to ASTM D1003 using Illuminant C.

In embodiments, at least one of the first glass-based layer 310 and the second glass-based layer 320 may have a composition comprising: about 50 mol % to about 85 mol % SiO2, about 5 mol % to about 30 mol % Al2O3, and about 5 mol % to about 30 mol % B2O3. The glass-based layer may comprise glass compositions produced in accordance with U.S. Pat. Nos. 7,851,394 and/or 7,534,734, each of which are incorporated herein by reference in their entirety.

In embodiments, at least one of the first glass-based layer 310 and the second glass-based layer 320 may have alkali aluminosilicate compositions, such as those commonly subjected to ion exchange strengthening processes and used in mobile electronic device. The alkali aluminosilicate glasses may be used in the glass-based articles in ion exchanged or non-ion exchanged form. In embodiments, the alkali aluminosilicate glass-based layers may be substantially free or free of lithium. The glass-based layer may comprise glass compositions in accordance with U.S. Patent App. Pub. No. 2013/0122284 A1, published May 16, 2013, which is incorporated herein by reference in its entirety.

In embodiments, the first glass-based layer 310 is formed from a glass composition that exhibits an anomalous fracturing behavior. Examples of anomalous glass may be borosilicate glasses (such as the glasses described in PCT Patent Application No. PCT/US2021/61966, filed on Dec. 6, 2021, hereby incorporated by reference in its entirety) and Eagle XG® or 714AWF glass manufactured by Corning Incorporated. Such glasses tend to exhibit impact performance characteristics that are favorable over glasses exhibiting normal fracture behavior, where cracks extending radially from the indentation site tend to extend through the thickness of the glass, potentially leading to catastrophic failure. Anomalous glasses such as borosilicates may also tend to exhibit relatively low CTEs, limiting thermally-induced damage from environmental exposure.

The first polymer layer 315 may be formed from any appropriate polymer material. In embodiments, the first polymer layer 315 may comprise a resin, such as an optically clear resin, such as a commercially available resin commonly utilized to repair windshields. In embodiments, the first polymer layer 315 may comprise an ultraviolet curable resin or a heat curable resin. In embodiments, the first polymer layer 315 may comprise an epoxy or an acrylate. In embodiments, the first polymer layer 315 may also comprise photoinitiators to provide the desired curing behavior. Where multiple polymer layers are comprised (such as the example described herein with respect to FIG. 4) the polymer layers may be formed from the same material or from different materials. It should be generally understood that any properties described herein with reference to the first polymer layer may also be ascribed to any other polymer layers comprised in the glass-based articles.

The materials used to form the first polymer layer 315 (and any other polymer layers present) may be characterized on the basis of the glass transition temperature. The glass transition temperature influences the compressive stress produced as a result of the CTE mismatch of the first and second glass-based layers 310 and 320. In embodiments, the first polymer layer 315 has a glass transition temperature TgP1 greater than or equal to 20° C., such as greater than or equal to 30° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., or more. In embodiments, the first polymer layer 315 has a glass transition temperature TgP1 from greater than or equal to 20° C. to less than or equal to 200° C., such as greater than or equal to 30° C. to less than or equal to 190° C., greater than or equal to 40° C. to less than or equal to 180° C., greater than or equal to 50° C. to less than or equal to 170° C., greater than or equal to 60° C. to less than or equal to 160° C., greater than or equal to 70° C. to less than or equal to 150° C., greater than or equal to 80° C. to less than or equal to 140° C., greater than or equal to 90° C. to less than or equal to 130° C., greater than or equal to 100° C. to less than or equal to 120° C., greater than or equal to 20° C. to less than or equal to 110° C., and any and all sub-ranges formed from these endpoints. Unless otherwise indicated, the glass transition temperature of the polymer is measured by dynamic mechanical analysis.

The first polymer layer 315 may also be characterized based on the storage modulus. In embodiments, the storage modulus of the first polymer layer at temperatures between 0° C. and 40° C. is greater than or equal to 5 MPa and less than or equal to 20,000 MPa, such as greater than or equal to 2,000 MPa and less than or equal to 5,000 MPa, and any and all sub-ranges formed from these endpoints.

In embodiments, the first polymer layer 315 does not exhibit brittle deformation behavior at 20° C. Stated differently, the first polymer layer 315 may exhibit ductile deformation behavior at 20° C. The non-brittle deformation behavior of the first polymer 315 layer prevents cracks from extending from one glass-based layer through the polymer layer to another glass-based layer, also referred to as arresting the cracks.

The first polymer layer 315 may have optical properties that are compatible with the first and the second glass-based layers 310 and 320. In embodiments, the first polymer layer 315 may have a transmission of greater than or equal to 90% over a wavelength range of interest, as described herein. In embodiments, the material out of which the first polymer layer 315 is constructed is selected to have a post-curing refractive index np1, measured at 550 nm. In embodiments, np1 is selected to substantially match a refractive index ng1 of the first glass-based layer 310, measured at 550 nm, and/or a refractive index ng2 of the second glass-based layer 320, measured at 550 nm. In embodiments, np1−ng1 is less than or equal to 0.3 (e.g., less than or equal to 0.2, less than or equal to 0.1) at 550 nm. In embodiments, np1−ng2 is less than or equal to 0.3 (e.g., less than or equal to 0.2, less than or equal to 0.1). In embodiments, np1 is preferably selected to be within 0.1 of ng1. Such index matching may render any impact-induced flaws in the first glass-based layer 310 difficult to see by avoiding index contrast-induced reflections at the interface between the first glass-layer 310 and the first polymer layer 315. However, when the first polymer layer 315 is relatively thin (e.g., less than or equal to 75 μm) such index matching may not be necessary to reduce visibility of flaws.

The first polymer layer 315 may be relatively stiff, such as a polymer with an elastic modulus greater than or equal to 100 MPa at a strain rate of 1/s. The stiffness of the first polymer layer 315 may constrain the glass-based layers, preventing the growth of cracks in the glass-based layers and prevent the glass-based layer from flexing and breaking. The first polymer layer 315 may have an elastic modulus greater than or equal to 100 MPa at a strain rate of 1/s, such as greater than or equal to 105 MPa, greater than or equal to 110 MPa, greater than or equal to 115 MPa, greater than or equal to 120 MPa, greater than or equal to 125 MPa, or more. In embodiments, the stiffness of the polymer layer may be related to the thickness of the polymer layer, such that the elastic modulus of the polymer layer divided by the thickness of the polymer layer is greater than or equal to 1 MPa/μm, such as greater than or equal to 2 MPa/μm, greater than or equal to 3 MPa/μm, greater than or equal to 4 MPa/μm, greater than or equal to 5 MPa/μm, greater than or equal to 6 MPa/μm, greater than or equal to 7 MPa/μm, greater than or equal to 8 MPa/μm, greater than or equal to 9 MPa/μm, greater than or equal to 10 MPa/μm, or more. Unless otherwise indicated, the elastic modulus of the polymer is measured by dynamic mechanical analysis.

The first polymer layer 315 may also be resistant to fracture. In embodiments, the polymer layers have a fracture toughness greater than or equal to 0.8 MPa√m, such as greater than or equal to 0.81 MPa√m, greater than or equal to 0.82 MPa√m, greater than or equal to 0.83 MPa√m, greater than or equal to 0.84 MPa√m, greater than or equal to 0.85 MPa√m, or more.

The first polymer layer 315 may also be characterized on the basis of volume change as a function of temperature. This phenomenon is commonly referred to as shrinkage. The polymer may also exhibit shrinkage as a result of the curing process. In embodiments, the polymer undergoes a shrinkage of greater than or equal to 1% during the curing process, such as greater than or equal to 2%, greater than or equal to 3%, or more.

In embodiments, the first polymer layer 315 may comprise one or more additives to alter the properties thereof. In embodiments, the polymer layers may comprise carbon nanotubes, such as multi-walled carbon nanotubes. The inclusion of carbon nanotubes in the polymer layers may increase the resistance of the glass-based articles to fracture, such as indicated by a ball drop test. Without being bound by any particular theory, the inclusion of carbon nanotubes in the polymer increases the storage modulus, Young's modulus, and tensile strength of the polymer layer producing the improved crack resistance. In embodiments, the polymer layers may comprise carbon nanotubes in an amount of about 1%.

In embodiments, the first polymer layer 315 comprises one or more colorants. The inclusion of colorants in the first polymer layer 315 may impart a pleasing aesthetic appearance to the glass-based article as a whole without degrading the mechanical properties thereof. In embodiments, the polymer layer may comprise a colorant in the amount of greater than or equal to 0.1 wt % to less than or equal to 30 wt %. The colorant may be selected for compatibility with the composition of the polymer layer. For example, epoxy-based colorants may be employed when the polymer layer is an epoxy. For example, in the case of epoxy adhesives one can dope epoxy-based colorants such as Epoxicolor® series from Specialty Polymers & Services into the epoxy precursor mix at ranges of 0.1-30% by weight. Similarly, Orcozinedyes and Orco Tint NS dyes from Orco (Organic Dyes and Pigments) can also be used for acrylate-based adhesives. A suitable pigment dispersion (e.g., comprising a suitable pigment and monomer) may be incorporated into the material used to form the first polymer layer 315.

In embodiments, the glass-polymer laminate 300 may appear transparent and colorless. In embodiments, the glass-polymer laminate 300 may have a transmission of greater than or equal to 90% over the wavelength range of 400 nm to 750 nm, such as greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, or more.

The glass-polymer laminate 300 articles may have any appropriate geometry. In embodiments, the glass-polymer laminate 300 is substantially flat or planar. In some embodiments, the glass-polymer laminate 300 may comprise openings or notches, such as openings to accommodate cameras, speakers, microphones, or finger-print sensors.

The glass-polymer laminates described herein may be produced by any appropriate lamination process. In general, the glass-based laminates are produced by disposing a polymer layer between glass-based layers, and then curing the polymer layer in an environment at a temperature that is different than the intended usage temperature. Where more than two glass-based layers are to be comprised in the glass-based articles, the disposing step may be repeated for each additional glass-based layer to be added to form a laminate stack. In embodiments where more than one polymer layer is present, all of the polymer layers may be cured concurrently.

The glass-based article may be cut or machined to a desired geometry after lamination and curing of the polymer layer. This allows large sheets of the glass-based articles to be formed and subsequently cut to the desired part size, increasing manufacturing efficiency and flexibility. After cutting the glass-based articles into the desired part size, edge finishing processes may be utilized to reduce the flaw population on the cut edges and produce an edge profile that is less susceptible to failure when the glass-based article is subjected to bending stresses. In embodiments, the glass-based layers may be cut and machined to a desired final geometry before assembly and curing of the laminate stack.

The disposition of the polymer layer may be carried out with any method capable of producing a polymer layer with the desired thickness. In embodiments, the polymer layer may be disposed using a doctor blade, roller, spray system, or any other technique known in the art. In embodiments, the polymer layers are disposed using flexographic or gravure printing techniques. Selecting appropriate disposition techniques allows the thickness of the polymer layer to be uniformly controlled. In embodiments, flexographic or gravure printing techniques are employed to produce a polymer layer with a thickness variation of less than or equal to 3 μm. The polymer layers may be formed from a liquid adhesive composition. In embodiments, the polymer layer may be deposited as a pre-formed film. After the polymer layer is disposed between the glass-based layers, pressure may be applied to the glass-based layers to remove any air bubbles or excess polymer from the laminate.

The curing of the polymer layer occurs in an environment at a curing temperature TC, where the curing temperature is different than the intended usage temperature (such as room temperature). After the polymer layer is cured, the glass-based article is returned to the intended usage temperature, and the difference in CTE between the glass-based layers produces a compressive stress in the glass-based article, such as in the first glass-based layer 310. In embodiments, the difference between TC and room temperature (|TC−20° C.|) is greater than or equal to 10° C., such as greater than or equal to 15° C., greater than or equal to 20° C., greater than or equal to 25° C., greater than or equal to 30° C., greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., greater than or equal to 95° C., greater than or equal to 100° C., greater than or equal to 105° C., greater than or equal to 110° C., greater than or equal to 115° C., greater than or equal to 120° C., or more. The laminate may be held in the curing temperature environment for a period of time prior to curing the polymer, which may be referred to as pre-heating. This allows the laminate to substantially equilibrate to the curing temperature. In embodiments, the laminate may be maintained in the curing temperature environment for greater than or equal to 2 minutes, such as greater than or equal to 3 minutes, greater than or equal to 4 minutes, greater than or equal to 5 minutes, greater than or equal to 6 minutes, greater than or equal to 7 minutes, greater than or equal to 8 minutes, greater than or equal to 9 minutes, greater than or equal to 10 minutes, or more.

In embodiments, the polymer layer may be cured by irradiating the polymer layer with ultraviolet radiation. In embodiments, the polymer layer may be cured by heat treating the polymer layer, such as by heating the laminate as a whole or by locally heating the polymer layer. For example, the laminate may be placed in an oven, in a furnace, or on a hot plate to heat treat and cure the polymer layer. In some embodiments, a combination of ultraviolet radiation and heat treatment may be employed to cure the polymer layer. The ultraviolet irradiation for curing the polymer layer may extend for any time period sufficient to produce the desired level of curing. In embodiments, the UV irradiation extends for a time period of greater than or equal to 0.5 min, such as greater than or equal to 1 min, greater than or equal to 2 min, greater than or equal to 3 min, greater than or equal to 4 min, greater than or equal to 5 min, greater than or equal to 6 min, greater than or equal to 7 min, greater than or equal to 8 min, greater than or equal to 9 min, greater than or equal to 10 min, or more. The curing may take place in any environment capable of maintaining the desired curing temperature and accommodating the glass-based articles. In embodiments, the curing takes place in an oven, furnace, refrigerator, freezer, or other environmental chamber.

The curing temperature may be above or below the intended usage temperature, with the relative CTE values of the glass-based layers selected accordingly to produce a compressive stress in the exposed glass-based layers, such as the first glass-based layer 310. In embodiments, TC is greater than or equal to 30° C. (e.g., greater than or equal to 50° C.) and CTEG2>CTEG1. In embodiments, TC is less than or equal to 0° C. and CTEG1>CTEG2. The curing temperature may also be selected based on the glass transition temperature of the polymer layer. In embodiments, the curing temperature is great than or equal to 10° C. more than the glass transition temperature of the polymer layer (TC≥TgP1+10° C.).

The glass-based articles may be subjected to an additional ultraviolet irradiation after returning to the usage temperature, such as room temperature. The additional ultraviolet irradiation ensures that the polymer layer is completely cured. In embodiments, the additional UV irradiation extends for a period of greater than or equal to 1 min, such as greater than or equal to 2 min, greater than or equal to 3 min, greater than or equal to 4 min, greater than or equal to 5 min, greater than or equal to 6 min, greater than or equal to 7 min, greater than or equal to 8 min, greater than or equal to 9 min, greater than or equal to 10 min, or more.

The process of producing the glass-based articles may comprise a heat treatment step after curing the polymer layer. In embodiments, the glass-based article is heated to a temperature greater than or equal to 40° C. after the polymer layer is cured. This additional heat treatment may assist in further curing the polymer layer.

FIG. 4 schematically depicts a glass-polymer laminate 400, according to an example embodiment. In embodiments, the glass-polymer laminate 400 may be used in place of the glass-polymer laminate 300 described herein as the window 24 of the LiDAR system 12 (see FIG. 2). The glass-polymer laminate 400 is depicted to comprise a first glass-based layer 410, a first polymer layer 415, a second glass-based layer 420, a second polymer layer 425, and a third glass-based layer 430. As shown in FIG. 4, the first glass-based layer 410 comprises a thickness 412, the second glass-based layer 420 comprises a thickness 422, and the third glass-based layer 430 comprises a thickness 432. In embodiments, the first and second glass-based layers 410 and 420 are outer glass-based layers, such that the outer surface 44 of the window 24 (see FIG. 2) is formed by the first glass-based layer 410, while the third glass-based layer 430 is an inner glass-based layer. As such, the thickness 432 may be substantially larger than the thicknesses 412 and 422. In embodiments, the first and second glass-based layers 410 and 420 are constructed (e.g., in terms of thickness and glass composition) in a manner similar to the first glass-based layer 310 of the glass-polymer laminate 300 described herein with respect to FIG. 3. In embodiments, the third glass-based layer 430 is constructed (e.g., in terms of thickness and glass composition) in a manner similar to the second glass-based layer 320 described herein with respect to FIG. 3.

In embodiments, the thicknesses 412 and 422 are (individually) less than or equal 20% (e.g., less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%) of the thickness 432. In embodiments, the thicknesses 412 and 422 are less than or equal to 300 μm (e.g., less than or equal to 200 μm, less than or equal to 175 μm, less than or equal to 150 μm, less than or equal to 125 μm, less than or equal to 100 μm, greater than or equal to 10 μm and less than or equal to 200 μm), while the thickness 432 is greater than 2.0 mm (e.g., greater than or equal to 2.1 mm, greater than or equal to 2.2 mm, greater than or equal to 2.3 mm, greater than or equal to 2.4 mm, greater than or equal to 2.5 mm, greater than or equal to 2.6 mm, greater than or equal to 2.7 mm, greater than or equal to 2.8 mm, greater than or equal to 2.9 mm, greater than or equal to 3.0 mm, all while being less than 3.8 mm). Such a combination of thicknesses aids in reducing the detrimental effects of impact-induced defects on optical performance, while providing sufficient stiffness to prevent significant warping during the lamination process.

In embodiments, the first and second glass-based layers 410 and 420 are constructed of glasses having a different (e.g., lower) CTE than that of the third glass-based layer 430, such that, after undergoing processing at the curing temperature described herein, both the first and second glass-based layers 410 and 420 have compressive stresses therein. As described herein, embodiments are envisioned where the first and second glass-based layers 410 and 420 comprise the same thickness and compositions. Embodiments are also envisioned where the first and second glass-based layers 410 and 420 differ from one another in at least one of thickness and composition.

The first and second polymer layers 415 and 425 may be constructed similar to the first polymer layer 315 of the glass-polymer laminate 300 described herein with respect to FIG. 3. As shown, the first polymer layer 415 comprises a thickness 416 and the second polymer layer comprises a thickness 416. In embodiments, both the thicknesses 416 and 426 (individually) are greater than or equal to 1 μm to less than or equal to 150 μm, such as from greater than or equal to 4 μm to less than or equal to 145 μm, from greater than or equal to 6 μm to less than or equal to 140 μm, from greater than or equal to 8 μm to less than or equal to 135 μm, from greater than or equal to 10 μm to less than or equal to 130 μm, from greater than or equal to 15 μm to less than or equal to 125 μm, from greater than or equal to 20 μm to less than or equal to 120 μm, from greater than or equal to 25 μm to less than or equal to 115 μm, from greater than or equal to 30 μm to less than or equal to 110 μm, from greater than or equal to 35 μm to less than or equal to 105 μm, from greater than or equal to 40 μm to less than or equal to 100 μm, from greater than or equal to 45 μm to less than or equal to 95 μm, from greater than or equal to 50 μm to less than or equal to 90 μm, from greater than or equal to 55 μm to less than or equal to 85 μm, from greater than or equal to 60 μm to less than or equal to 80 μm, from greater than or equal to 65 μm to less than or equal to 75 μm, from greater than or equal to 2 μm to less than or equal to 70 μm, and any and all sub-ranges formed from these endpoints. As described herein, embodiments are envisioned where the first and second polymer layers 415 and 425 comprise the same thickness and compositions. Embodiments are also envisioned where the first and second polymer layers 415 and 425 differ from one another in at least one of thickness and composition.

In embodiments, a combined thickness of the first and second glass-based layers 410 and 420 (i.e., a combined outer layer thickness of the relatively thin outer glass-based layers of the glass-polymer laminate 400) is less than or equal to 300 μm (e.g., less than or equal to 300 μm and greater than or equal to 15 μm, less than or equal to 300 μm and greater than or equal to 30 μm, less than or equal to 300 μm and greater than or equal to 50 μm, less than or equal to 300 μm and greater than or equal to 30 μm, less than or equal to 300 μm and greater than or equal to 100 μm, less than or equal to 300 μm and greater than or equal to 200 μm). Such a combined outer layer thickness facilitates each of the first and second glass-based layers 410 and 420 being thin enough to avoid defects from twisting out of plane and becoming more visible, while still being thick enough to prevent impact-induced flaws from reaching the third glass-based layer 430, which, as described herein, may be under tensile stress tending to expand flaws.

As described herein, the glass-polymer laminate 400 may be formed by creating a stack of the first, second, and third glass-based layers 410, 420, 430, with uncured versions of the first and second polymer layers 415 and 425 disposed therebetween. After being heated to a curing temperature outside of a usage temperature range, as described herein, where the polymeric materials of the first and second polymer layers 415 and 425 are cured, the stack is subsequently heated or cooled to the usage temperature range, where differential volumetric contraction occurs and the bonding of the first and second glass-based layers 410 and 420 to the third glass-based layer 430 via the first and second polymer layers 415 and 425 causes a compressive stress to be present in each of the first and second glass-based layers 410 and 420. In embodiments, the average compressive stress within the first glass-based layer 410 is smaller in magnitude than the average compressive stress within the second glass-based layer 420 as a result of the indirect connection between the first glass-based layer 410 and the third glass-based layer 430. In embodiments, each of the first and second glass-based layers 410 and 420 comprise an average compressive stress that is greater than or equal to 5 MPa and less than or equal to 40 MPa.

As compared to the glass-polymer laminate 300 described herein with respect to FIG. 3, the glass-polymer laminate 400 may provide further improved impact performance. The additional polymer layer (the first polymer layer 415 disposed between the first and second glass-based layers 410 and 420) may make micro impact induced damage severity less pronounced due to localized deformation thereof (thereby attenuating energy associated with impacts). Itis believed that the additional polymer layer provides an additional glass-polymer interface through which cracks must propagate to reach the tensile third glass-based layer 430, thereby increasing the damage threshold for spreading flaws. In embodiments, the combined outer glass-based layer thickness of the glass-polymer laminate 400 (i.e., the sum of the thicknesses 412 and 422) may be greater than the thickness 50 of the first glass-based layer 310 described with respect to FIG. 3. As a result, the glass-polymer laminate 400 may have a greater thickness of glass that can be damaged without significant visibility as compared to the glass-polymer laminate 300. It is believed that the glass-polymer laminate 400 may provide improved impact performance over certain embodiments of the glass-polymer laminate 300 described herein with respect to FIG. 3, especially when the combined outer glass-based layer thickness is greater than the thickness 50.

In embodiments, the presence of multiple polymer layers may eliminate the need for CTE-induced compressive stress in the glass-polymer laminate 400. That is, embodiments are envisioned where the glass-polymer laminate 400 is constructed so as to not comprise CTE-induced compressive stress (e.g., the glass-based layers may be constructed of glasses having comparable CTEs or the stack may not be heated or cooled to a curing temperature during lamination). In such embodiments, it is believed that the multiple adhesive layers would play the role of damage absorption as well as a provide a mechanism for preventing impact-induced damage from propagating to the third glass-based layer 430.

In embodiments, itis believed that impact-induced flaws in the second glass-based layer 420 will be particularly difficult to see, especially when the first and second polymer layers 415 and 425 are selected to have refractive indices that substantially match that of the second glass-based layer 420, as described herein. Accordingly, it is believed that the glass-polymer laminate 400 may allow absorption of a wider range of impact events than the glass-polymer laminate 300, without degrading the optical performance of the window 24 to a significant degree.

While the embodiment described herein with respect to FIG. 4 only comprised two relatively-thin outer glass-based layers, it should be understood that embodiments comprising more outer glass-based layers (e.g., 3, 4, 5, 6, 7, or even more outer glass-based layers) are contemplated and within the scope of the present disclosure. In such embodiments, each of the outer glass-based layers may be similar in composition and construction to the first outer glass-based layer 310 described herein with respect to FIG. 3. If 4 or more outer glass-based layers are comprised, the glass-polymer laminate may not comprise a relatively thick inner glass-based layer. Such embodiments may not comprise CTE-induced compressive stresses in any of the layers, as the number of polymer layers present may provide sufficient impact performance. Eliminating CTE-induced compressive stress may also eliminate warp concerns. It should be understood that increasing the number of polymer layers in the glass-polymer laminates described herein may have detrimental effects on optical transmission, rendering such laminates unsuitable for certain applications.

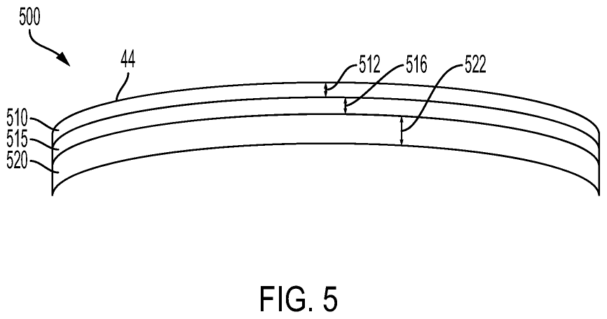

Referring now to FIG. 5, a curved glass-polymer laminate 500 is schematically depicted, according to an example embodiment. In embodiments, the curved glass-polymer laminate 500 may be used in place of the glass-polymer laminate 300 described herein with respect to FIG. 3 as the window 24 for the LiDAR system 12 (see FIG. 2). The glass-polymer laminate 500 is depicted to comprise a first glass-based layer 510, a first polymer layer 515, and a second glass-based layer 520. The curved glass-polymer laminate 500 may generally have a similar structure and be formed using similar techniques as described herein with respect to the glass-polymer laminate 300 described herein with respect to FIG. 3 (e.g., such that thicknesses 512, 516, and 522 of the first glass-based layer 510, first polymer layer 515, and second glass-based layer 520, respectively, correspond to the thicknesses 50, 56, and 52). In embodiments, the first and second glass-based layers 510 and 520 comprise similar thicknesses and compositions as the first and second glass-based layers 310 and 320, and may only differ in that the first and second glass-based layers 510 and 520 are pre-formed (e.g., via a suitable hot forming process) to have the depicted curved shape. Embodiments where at least one of the first and second glass-based layers 510 and 520 are cold-formed into a non-planar shape are also contemplated.

In embodiments, warpage of the curved glass-polymer laminate 500 during the lamination process described herein is leveraged to form the curved shape, despite the first and second glass-based layers 510 and 520 being initially flat prior to lamination. In such embodiments, the thickness 522 of the second glass-based layer 520 may be less than the second glass-based layer 320 described herein with respect to FIG. 3. In embodiments, the thickness 522 is less than or equal to 1.5 mm (e.g., less than or equal to 1.4 mm, less than or equal to 1.3 mm, less than or equal to 1.2 mm, less than or equal to 1.1 mm, less than or equal to 1.0 m) and greater than or equal to 100 μm. As a result of differential volumetric contraction during heating or cooling after curing of the first polymer layer 515, the second glass-based layer 520, when constructed of a higher CTE glass, contracts to a greater extent than the first glass-based layer 510. The bonding to the first glass-based layer 510 inhibits contraction of the second glass-based layer 520 to a certain extent, leading to a strain distribution in the second glass-based layer 520. The reduced thickness of the second glass-based layer 520 renders the second glass-based layer 520 less stiff, causing the strain distribution to manipulate the shape of the second glass-based layer 520. Bonding between the first and second glass-based layers 510 and 520 causes the first glass-based layer 510 to bend in conjunction with the second glass-based layer 520.

The thickness and composition of the first and second glass-based layers 510 and 520 may be chosen such that the warpage provides a desired curvature. Rendering the outer surface 44 convex in shape may be beneficial in that impacting objects may be directed away from a line of sight of the LiDAR system 12 (see FIG. 2). The convex shape may also serve to focus the emitted radiation 22 or the reflected radiation 28.

In embodiments, the first glass-based layer 510 comprises a compressive stress from the CTE mismatch between the first and second glass-based layers 510 and 520. For example, the first glass-based layer 510 may comprise an average compressive stress that is greater than or equal to 5 MPa and less than or equal to 40 MPa, while the second glass-based layer 520 may comprise an average tensile stress that is less than or equal to 10 MPa. The curved glass-polymer laminate 500 may provide the impact performance benefits described herein, while having a warpage-induced curved shape suitable for a particular application.

### EXAMPLES

Embodiments of the present disclosure may be further understood in view of the following examples.

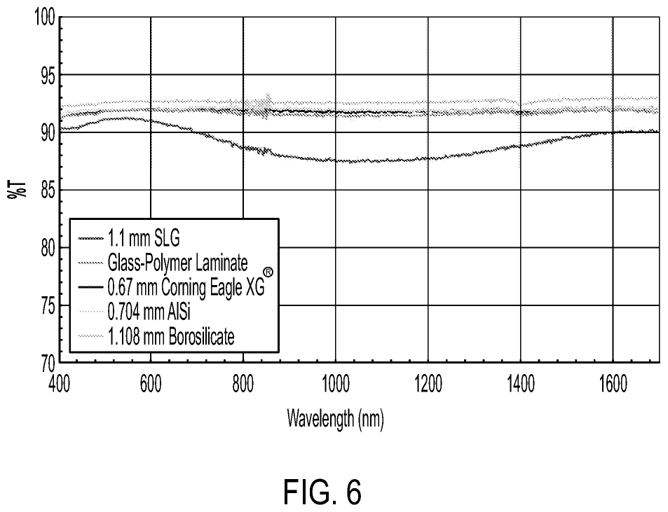

Optical transmission of a glass-polymer laminate constructed of materials similar to those described herein with respect to FIGS. 3-5 was measured and compared to various monolithic glass sheets to determine the suitability of the glass-polymer laminates described herein for various sensor applications. FIG. 6 depicts the optical transmission measurement results. The glass-polymer laminate measured comprised a 1.5 mm thick inner glass-based layer constructed of an aluminosilicate composition (no IOX) disposed between two 0.2 mm thick outer glass-based layers constructed of Corning Eagle XG® glass. The 45 CPS Stone Chip Windshield Repair Resin produced by Ultra Bond, Inc (“UB45”) was used for polymer layers separating the inner glass-based layer from the outer-glass-based layer. The laminate was cured at 100° C. and subsequently cooled to room temperature such that a compressive stress was exhibited by the outer glass-based layers. As shown, the glass-polymer laminate exhibited comparable optical transmission performance to monolithic glass sheets of aluminosilicate and Corning Eagle XG® compositions. As shown, from 400 nm to 1650 nm, the optical transmission of the laminate was greater than 91%, comprising wavelength ranges immediately surrounding 905 nm and 1550 nm. Such results demonstrate the suitability of the glass-polymer laminates described herein for use in LiDAR systems.

### Examples 1 and 2

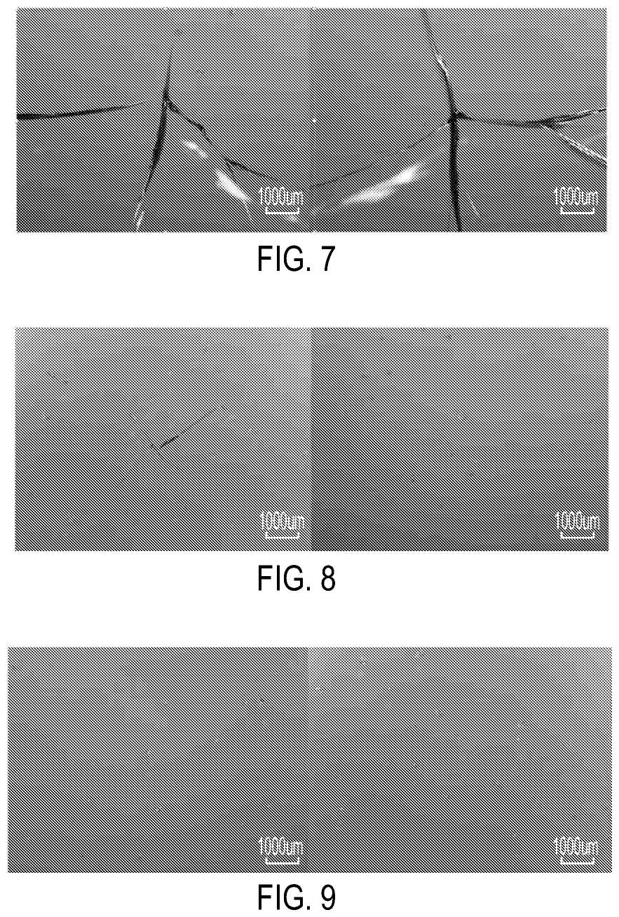

A pair of polymer-glass laminates were fabricated, with each of the glass laminates comprising two 2.1 mm thick outer glass layers formed of soda lime glass bonded to a UB45 polymer layer therebetween. Example 1 was cured at room temperature, while Example 2 was cured at a curing temperature of 100° C. The laminates were then subjected to sharp impact testing with sandpaper. Particularly, a ball structure was guided down a tube and dropped onto the articles from a height of eight inches, with one of the glass layers in contact with 120 grit sandpaper (the sandpaper was in contact with the side of the glass article not contacted by the ball). The results are shown in FIG. 7, with the left-hand image depicting a portion of Example 1 and the right-hand image depicting a portion of Example 2. As shown, regardless of curing temperature, the impact testing resulted in fractures that are highly visible. The relatively thick outer layers in these examples resulted in the fractures twisting out of plane so as to have high reflectivity, increasing the visibility of the fractures. The fractures are many 100s of microns in size, which would significantly impact optical performance of any sensor incorporating the laminates as a protective window. It is believed that the poor impact performance was a result of the thick outer layer and a lack of compressive stress in the laminate (from the glass-based layers having the same composition).

### Examples 3 and 4

A pair of glass-polymer laminates was prepared, with each of the glass-polymer laminates comprising a 0.2 mm thick outer glass layer formed of Corning® Eagle XG® glass and a 2.1 mm thick inner glass layer formed of soda lime glass. A polymer layer between the glass layer was formed of UB45. Example 3 was cured at room temperature, while Example 4 was cured at a curing temperature of 100° C. The laminates were then subjected to sharp impact testing with sandpaper. The results are shown in FIG. 8, with the left-hand image depicting a portion of Example 3 and the right-hand image depicting a portion of Example 4. Both examples demonstrate marked improvement over Examples 1 and 2. The relatively thin outer glass layer prevents the fractures from twisting out of plane, rendering them visible. Moreover, the compressive stress from the elevated curing temperature in Example 4 further reduced the visibility of the damage by maintaining the fractures in a closed state.

### Examples 5 and 6

Example 5 was a symmetrical glass-polymer laminate comprising two 0.2 mm thick outer glass layers formed of Corning® Eagle XG® glass and a 2.1 mm thick inner glass layer of soda lime glass. Two UB45 polymer layers were disposed between the glass layers. Example 6 was an asymmetric glass-polymer laminate structured similar to the glass-polymer laminate 400 described herein with respect to FIG. 4. Two 0.1 mm thick outer glass layers formed of Corning® Eagle XG® glass were disposed on a 2.1 mm thick inner glass layer of soda lima glass. Two UB45 polymer layers were disposed between the glass layers. Both examples 5 and 6 were cured at 100° C. The laminates were then subjected to sharp impact testing with sandpaper. The results are shown in FIG. 9, with the left-hand image depicting a portion of Example 5 and the right-hand image depicting a portion of Example 6. It can be seen that the asymmetrical laminate structure appeared to provide comparable results, in terms of fracture visibility, to the symmetrical laminate structure. In both cases, the relatively thick inner glass layer was not damaged.

As can be seen by comparing Example 4 to Example 6, the asymmetric laminate with multiple relatively thin outer glass layers exhibited significantly less visible damage. It is believed that this is due to the compressive stress in the thin layers and the additional adhesive material deforming to prevent propagation of the fracture. Itis also noted that damage to the second outer glass layer (the thin outer glass layer not directly impacted) was mostly suppressed and damage in that layer was mostly not visible with the naked eye. These results demonstrate the efficacy of incorporating additional thin outer glass layers in further suppressing impact-induced damage.

### Examples 7-12

The following six laminate structures were constructed by creating stacks of the following glass layer constructions with UB45 adhesive layers between the glass layers (each of the samples had a size of 5.08 cm×5.08 cm):
Example 7: 0.1 mm EXG, 0.1 mm EXG, 2.1 mm SLG;
Example 8: 0.2 mm EXG, 0.2 mm EXG, 2.1 mm SLG;
Example 9: 0.1 mm EXG, 2.1 mm SLG, 0.1 mm EXG;
   Example 10: 0.1 mm EXG, 2.1 mm SLG;
   Example 11: 0.2 mm EXG, 2.1 mm SLG;
Example 12: 0.2 mm EXG, 2.1 mm SLG, 0.2 mm EXG;
   Where EXG represents Corning® Eagle XG® glass and SLG represents soda lime glass. Each of examples 7-12 was heated to a curing temperature of 100° C. for the UB45 adhesive layers to cure with UV.

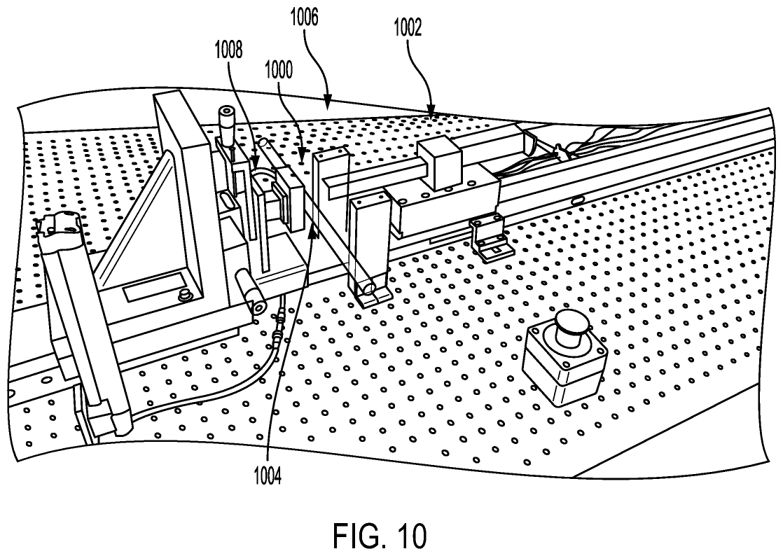

Each of examples was then subjected to dynamic damage introduction testing using the experimental setup depicted in FIG. 10. As shown, a variable speed impactor 1000 is positioned on a modular impactor holder 1002 to generate an impact with a sample 1004. The variable speed impactor 1000 comprises a Vickers diamond tip indenter. A speed gate 1006 was positioned just upstream of the sample 1004 to measure the speed of the impactor 1000 just prior to impacting the sample 1004. The sample 1004 was positioned in contact with a 3-axis piezoelectric load cell 1008 capable of measuring loads of up to 4400 N at a sampling rate of 200 kHz. Samples of each of the Examples 7-12 were tested using the following approach: each sample 1004 was subjected to up to five indentations at a given velocity (800 mm/s, 1000 mm/s, 1250 mm/s, 1500 mm/s, 2000 mm/s, 2500 mm/s). If a sample 1004 was not damaged to a significant extent in a first impact event at a center of the sample 1004, additional indentations were at 12 o'clock, 3 o'clock, 6 o'clock, and 9 o'clock positions approximately 2500 μm from the center were made. The samples were assessed for impact severity at each impact velocity

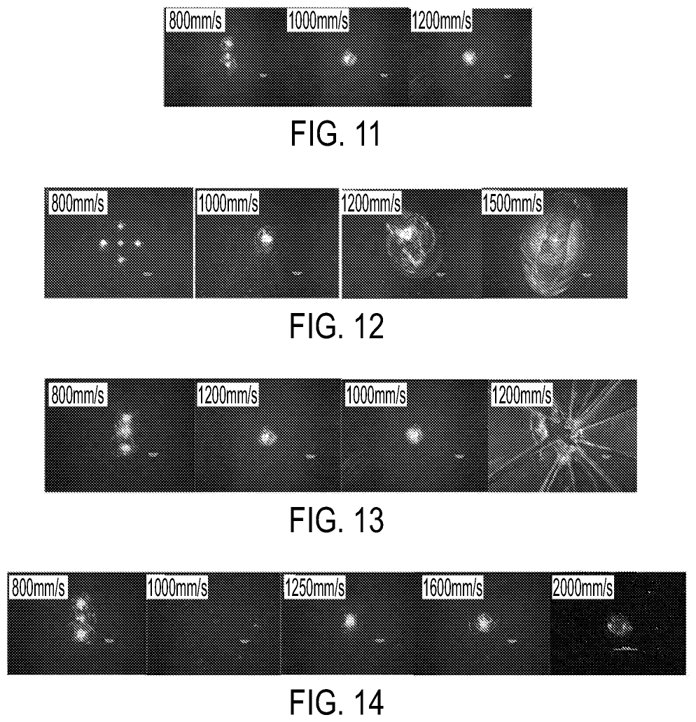

The results for Example 7 are depicted in FIG. 11 and summarized in the Table 1 below:

TABLE 1

| Impact Velocity (m/s) | Impact Load (N) |
|---|---|
| 800 | 840.39 |
| 800 | 1312.95 |
| 800 | 1297.05 |
| 1000 | 960.49 |
| 1250 | 1286.38 |

The results for Example 8 are depicted in FIG. 12 and summarized in the Table 2 below:

TABLE 2

| Impact Velocity (m/s) | Impact Load (N) |
|---|---|
| 800 | 867.92 |
| 800 | 1317.47 |
| 800 | 1356.57 |
| 800 | 1649.16 |
| 800 | 1478.32 |
| 1000 | 1878.13 |
| 1250 | 1893.80 |
| 1250 | 1930.18 |

The results for Example 9 are depicted in FIG. 13 and summarized in the Table 3 below:

TABLE 3

| Impact Velocity (mm/s) | Impact Load (N) |
|---|---|
| 800 | 1104.98 |
| 800 | 1658.91 |
| 800 | 1618.23 |
| 1200 | 1638.26 |
| 1000 | 1050.25 |
| 1200 | 1034.50 |

The results for Example 10 are depicted in FIG. 14 and summarized in the Table 4 below:

TABLE 4

| Impact Velocity (mm/s) | Impact Load (N) |
|---|---|
| 800 | 803.435 |
| 800 | 803.027 |
| 800 | 759.032 |
| 1000 | 1005.506 |
| 1250 | 1280.471 |
| 1600 | 1547.249 |
| 2000 | 1946.995 |

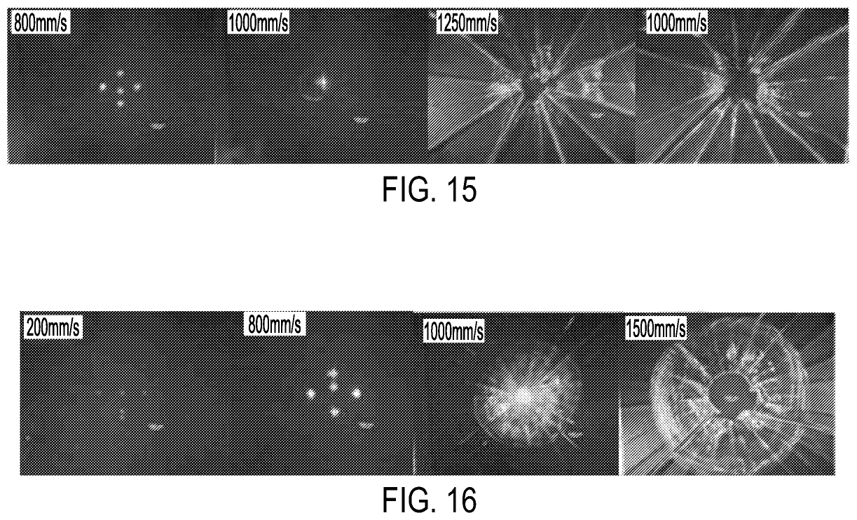

The results for Example 11 are depicted in FIG. 15 and summarized in the Table 5 below:

TABLE 5

| Impact Velocity (mm/s) | Impact Load (N) |
|---|---|
| 800 | 813.027 |
| 800 | 813.058 |
| 800 | 815.894 |
| 800 | 809.429 |
| 800 | 795.051 |
| 1000 | 1009.57 |
| 1250 | 1275.65 |
| 1000 | 1007.671 |

The results for Example 12 are depicted in FIG. 16 and summarized in the Table 6 below:

TABLE 6

| Impact Velocity (mm/s) | Impact Load (N) |
|---|---|
| 200 | 179.708 |
| 200 | 171.152 |
| 200 | 177.147 |
| 200 | 164.96 |
| 200 | 169.59 |
| 800 | 796.519 |
| 800 | 810.463 |
| 800 | 808.681 |
| 800 | 805.938 |
| 800 | 808.441 |
| 1000 | 1002.614 |
| 1500 | 1552.965 |

As demonstrated by FIGS. 11-16 and Tables 1-6, the examples with asymmetric structures comprising a thin outer glass layer disposed on one side of a thick inner glass layer (with the thin outer glass layer being directly impacted) appear to exhibit superior impact performance. Notably, Example 10, comprising only one relatively thin outer glass-based layer did not fail or fracture at impact velocities of 1600 mm/s and 2000 mm/s. As shown in the rightmost image contained in FIG. 14, the flaw generated at 2000 mm/s had an approximate diameter of about 1000 μm, while each of the other examples, when tested at speeds above 1200 mm/s, either exhibited much larger flaws or completely shattered. At lower impact speeds of 800 mm/s, the examples with multiple relatively thin outer glass layers disposed on one side of inner glass layer (Examples 7 and 8) had superior performance, generally having smaller flaw sizes at comparable load levels. It is also worth noting that each of Examples 7-12 performed superior to monolithic glass, which was found to typically fail at velocities of 500 mm/s or less.

These results demonstrate the ability of the glass-polymer laminates described herein to survive a greater variety of impact events than existing monolithic cover windows without cracks extending completely therethrough. Moreover, the damage caused by certain impact events may be reduced due to the flexibility of the relatively thin outer glass layers and the compressive stress therein, and the polymer layers preventing flaws from reaching the relatively thick inner glass layer.

It will be apparent to those skilled in the art that various modifications and variations can be made without departing from the spirit or scope of the claims.

1. An article, comprising:
a first glass-based layer having a thickness t_{G1} and a coefficient of thermal expansion CTE_{G1};
a second glass-based layer having a thickness t_{G2} and a coefficient of thermal expansion CTE_{G2}; and
a first polymer layer disposed between the first glass-based layer and the second glass-based layer having a thickness t_{P1} and a coefficient of thermal expansion CTE_{P1},
wherein:
the first glass-based layer comprises a compressive stress,

|CTE_{G1}−CTE_{G2}|>0.5 ppm/° C.,
t_{G2} is greater than 2.0 mm, and
t_{G1} is less than or equal to 300 μm.

2. The article of claim 1, wherein:
t_{G1} is less than or equal to 200 μm, and
t_{G2} is greater than 2.5 mm and less than or equal to 3.8 mm.

3. The article of claim 2, wherein:
the compressive stress is greater than or equal to 5 MPa and less than or equal to 40 MPa, and
the second glass layer comprises a tensile stress that is less than or equal to 10 MPa.

4. (canceled)

5. The article of claim 1, wherein the first glass-based layer is formed from a glass exhibiting an anomalous fracture behavior when subjected to a Vickers diamond indenter test.

6. The article of claim 1, wherein the first glass-based layer is not chemically strengthened and the compressive stress arises from laminating the first glass-based layer to the second glass-based layer via the first polymer layer at a curing temperature differs from a usage temperature of the article by at least 20° C.

7. The article of claim 1, wherein CTE_{G1}<CTE_{G2} and the curing temperature is greater than or equal to 30° C.

8. (canceled)

9. The article of claim 1, further comprising:
a third glass-based layer having a thickness t_{G3} and a coefficient of thermal expansion CTE_{G3}, and
a first polymer layer disposed between the first glass-based layer and the third glass-based layer having a thickness t_{P2} and a coefficient of thermal expansion CTE_{P2}, wherein:
the second glass-based layer comprises a second compressive stress,

|CTE_{G2}−CTE_{G3}|>0.5 ppm/° C., and
t_{G3} is less than or equal to 20% of t_{G2}.

10. (canceled)

11. The article of claim 9, wherein t_{G2} is greater than or equal to 2.5 mm and less than or equal to 3.8 mm.

12. The article of claim 9, wherein the first glass-based layer and the second glass-based layer are formed of the same glass composition such that CTE_{G2}=CTE_{G3}.

13. The article of claim 9, wherein t_{G1}=t_{G3} and both t_{G1} and t_{G3} are less than or equal to 150 μm.

14. (canceled)

15. The article of claim 1, wherein the article is not fractured when the first glass-based layer is impacted by a Vickers diamond indenter travelling at a speed of 1000 mm/s.

16. (canceled)

17. A sensor comprising:
an enclosure;
a detection element disposed in the enclosure; and
a window attached to the enclosure so as to enclose an interior of the enclosure, wherein the window comprises:
a first glass-based layer having a thickness t_{G1} and a coefficient of thermal expansion CTE_{G1};
a second glass-based layer having a thickness t_{G2} and a coefficient of thermal expansion CTE_{G2}; and
a first polymer layer disposed between the first glass-based layer and the second glass-based layer having a thickness t_{P1} and a coefficient of thermal expansion CTE_{P1},
wherein:
the first glass-based layer comprises a compressive stress of greater than or equal to 5 MPa and less than or equal to 40 MPa arising from a difference between CTE_{G1} and GTE_{G2},
t_{G1} is less than or equal to 300 μm, and
t_{G2} is greater than 2.0 mm.

18. The sensor of claim 17, wherein:
t_{G1} is less than or equal to 200 μm, and
t_{G2} is greater than or equal to 2.5 and less than or equal to 3.8 mm.

19. The sensor of claim 17, wherein:
the first glass-based layer is formed from a glass exhibiting an anomalous fracture behavior when subjected to a Vickers diamond indenter test, and
the first glass-based layer forms an outer surface of the window that is exposed to an environment outside of the enclosure.

20. (canceled)

21. The sensor according to claim 17, further comprising:
a third glass-based layer having a thickness t_{G3} and a coefficient of thermal expansion CTE_{G3}, and
a first polymer layer disposed between the first glass-based layer and the third glass-based layer having a thickness t_{P2} and a coefficient of thermal expansion CTE_{P2}, wherein:
the second glass-based layer comprises a second compressive stress,

|CTE_{G2}−CTE_{G3}|>0.5 ppm/° C., and
t_{G3} is less than or equal to 10% of t_{G2}.

22. The sensor of claim 21, wherein both t_{G1} and t_{G3} are less than or equal to 200 μm, wherein t_{G2} is greater than or equal to 2.5 mm and less than or equal to 3.8 mm.

23. (canceled)

24. The sensor of claim 21, wherein the first glass-based layer and the third glass-based layer are formed of the same glass composition such that CTE_{G1}=CTE_{G3}, wherein t_{G1}=t_{G3} and both t_{G1} and t_{G3} are less than or equal to 150 μm.

25. (canceled)

26. A method, comprising:
disposing a first polymer layer between a first glass-based layer and a second glass-based layer, wherein the first glass-based layer has a thickness that is less than or equal to 15% of a thickness of the second glass-based layer and wherein the thickness of the second glass-based layer is greater than 2.0 mm;
curing the first polymer layer in an environment at a curing temperature T_{C} to form an article; and
after the curing, returning a temperature of the first glass-based layer and the second glass-based layer to a usage temperature that is greater than or equal to 0° C. and less than or equal to 30° C., wherein:
a first coefficient of thermal expansion of the first glass-based layer differs from a second coefficient of thermal expansion of the second glass-based layer by at least 0.5 ppm/° C., and
T_{C} differs from the usage temperature by at least 20° C. such that returning the temperature to the usage temperature results in the first glass-based layer having a compressive stress that is greater than or equal to 8 MPa and less than or equal to 40 MPa.

27. The method of claim 26, further comprising, prior to the curing, disposing a second polymer layer between the first glass-based layer and a third glass-based layer, wherein the third glass-based layer has a thickness that is less than or equal to 10% of a thickness of the second glass-based layer.

28. The method of claim 27, wherein a third coefficient of thermal expansion of the third glass-based layer differs from the second coefficient of thermal expansion by at least 0.5 ppm/° C. such that, after being returned to the usage temperature, the third glass-based layer comprises a second compressive stress.

29. (canceled)

30. (canceled)
